(19) United States
(12) Patent Application Publication
(10) Pub. No.: US 2017/0166835 A1
(43) Pub. Date: Jun. 15, 2017

(54) Systems and Methods To Improve Co-Product Recovery From Grains And/Or Grain Components Used For Biochemical And/Or Biofuel Production Using Emulsion-Disrupting Agents

(71) Applicant: Fluid Quip Process Technologies, LLC, Springfield, OH (US)

(72) Inventor: Neal Jakel, Cedar Rapids, IA (US)

(21) Appl. No.: 15/216,031

(22) Filed: Jul. 21, 2016

Related U.S. Application Data
(62) Division of application No. 14/965,060, filed on Dec. 10, 2015.

(51) Int. Cl. C11B 1/10

(52) U.S. Cl. CPC C11B 1/108

(57) ABSTRACT

Systems and methods are provided for improving co-product recovery, such as oil recovery, from grains and/or gain components used for biochemical and/or biofuel production, such as alcohol (e.g., ethanol) production, using surfactants, flocculants, and/or other emulsion-disrupting agents. At one or more points prior to or during emulsion formation, as well as after emulsion formation, surfactants and/or flocculants are added to the biochemical and/or biofuel production process to prevent emulsions or break those already formed to improve co-product recovery, such as oil recovery.

### TECHNICAL FIELD

The present invention relates generally to systems and methods to improve co-product recovery, such as oil recovery, from grains and/or grain components used for biochemical and/or biofuel production, e.g., alcohol production, using emulsion-disrupting agents, including surfactants and/or flocculants.

### BACKGROUND

One chemical of great interest today is alcohol, such as ethanol, which can be produced from virtually any type of grain and/or grain component, or starch-containing material, but is most often made from corn. Most of the fuel ethanol in the United States is produced from a wet mill process or a dry grind ethanol process. Although virtually any type and quality of grain or grain component can be used to produce ethanol, the feedstock for these processes is typically a corn known as “No. 2 Yellow Dent Corn.” The “No. 2” refers to a quality of corn having certain characteristics as defined by the National Grain Inspection Association, as is known in the art. “Yellow Dent” refers to a specific type of corn as is known in the art.

The conventional methods for producing various types of biochemicals or biofuels, such as alcohol, from grain and/or grain components generally follow similar procedures, depending on whether the process is operated wet or dry. Wet mill corn processing plants convert corn grain and/or grain components into several different co-products, such as germ (for oil extraction), gluten feed (high fiber animal feed), gluten meal (high protein animal feed), and starch-based products such as ethanol, high fructose corn syrup, or food and industrial starch. Dry grind ethanol plants convert corn into two products, namely ethanol and distiller's grains with solubles. If sold as wet animal feed, distiller's wet grains with solubles is referred to as DWGS. If dried for animal feed, distiller's dried grains with solubles is referred to as DDGS. In the standard dry grind ethanol process, one bushel of corn yields approximately 8.2 kg (approximately 17 lbs) of DDGS in addition to the approximately 10.5 liters (approximately 2.8 gal) of ethanol. This co-product provides a critical secondary revenue stream that offsets a portion of the overall ethanol production cost.

With respect to the wet mill process, FIG. 1 is a flow diagram of a typical wet mill biochemical or bioefuel production process 10, such as an alcohol (e.g., ethanol) production process. The process 10 begins with a steeping step 12 in which corn is soaked for 24 to 48 hours in a solution of water and sulfur dioxide in order to soften the kernels for grinding, leach soluble components into the steep water, and loosen the protein matrix with the endosperm. Corn kernels contain mainly starch, fiber, protein, and oil. The mixture of steeped corn and water is then fed to a degermination mill step (first grinding) 14 in which the corn is ground in a manner that tears open the kernels and releases the germ so as to make a heavy density (8.5 to 9.5 Be) slurry of the ground components, primarily a starch slurry. This is followed by a germ separation step 16 that occurs by flotation and use of a hydrocyclone(s) to separate the germ from the rest of the slurry. The germ is the part of the kernel that contains the oil found in corn. The separated germ stream, which contains some portion of the starch, protein, and fiber, goes to germ washing to remove starch and protein, and then to a dryer to produce about 2.7 to 3.2 Lb. (dry basis) of germ per bushel of corn. The dry germ has about 50% oil content on a dry basis.

The remaining slurry, which is now devoid of germ, but containing fiber, gluten (i.e., protein), and starch, is then subjected to a fine grinding step (second grinding) 20 in which there is total disruption of endosperm and release of endosperm components, namely gluten and starch, from the fiber. This is followed by a fiber separation step 22 in which the slurry is passed through a series of screens in order to separate the fiber from starch and gluten, and to wash the fiber clean of gluten and starch. The fiber separation stage 22 typically employs static pressure screens or rotating paddles mounted in a cylindrical screen (e.g., paddle screens). Even after washing, the fiber from a typical wet grind mill contains 15 to 20% starch. This starch is sold with the fiber as animal feed. The remaining slurry, which is now devoid of fiber, is subjected to a gluten separation step 24 in which centrifugation or hydrocyclones separate starch from the gluten. The gluten stream goes to a vacuum filter and dryer to produce gluten (protein) meal.

The resulting purified starch co-product then undergoes a jet cooking step 26 to start the process of converting the starch to sugar. Jet cooking refers to a cooking process performed at elevated temperatures and pressures, although the specific temperatures and pressures can vary widely. Typically, jet cooking occurs at a temperature of about 100 to 120° C. (about 212 to 248° F.) and a pressure of about 2.8 to 5.6 kg/cm² (about 40 to 80 lbs/in²), although the temperature can be as low as about 104 to 107° C. (about 220 to 225° F.) when pressures of about 8.4 kg/cm² (about 120 lbs/in²) are used. This is followed by liquefaction 28, saccharification 30, fermentation 32, yeast recycling 34 and distillation/dehydration 36. Liquefaction occurs as the mixture, or “mash” is held at 90 to 95° C. in order for alpha-amylase to hydrolyze the gelatinized starch into maltodextrins and oligosaccharides (chains of glucose sugar molecules) to produce a liquefied mash or slurry. In the saccharification step 30, the liquefied mash is cooled to about 50° C. and a commercial enzyme known as gluco-amylase is added. The gluco-amylase hydrolyzes the maltodextrins and short-chained oligosaccharides into single glucose sugar molecules to produce a liquefied mash. In the fermentation step 32, a common strain of yeast (Saccharomyces cerevisae) is added to metabolize the glucose sugars into ethanol and CO₂.

Upon completion, the fermentation mash (“beer”) will contain about 17% to 18% ethanol (volume/volume basis), plus soluble and insoluble solids from all the remaining grain components. The solids and some liquid remaining after fermentation go to an evaporation stage where yeast can be recovered as a co-product. Yeast can optionally be recycled in a yeast recycling step 34. In some instances, the CO₂ is recovered and sold as a commodity product. Subsequent to the fermentation step 32 is the distillation and dehydration step 36 in which the beer is pumped into distillation columns where it is boiled to vaporize the ethanol. The ethanol vapor is condensed in the distillation columns, and liquid alcohol (in this instance, ethanol) exits the top of the distillation columns at about 95% purity (190 proof). The 190 proof ethanol then goes through a molecular sieve dehydration column, which removes the remaining residual water from the ethanol, to yield a final product of essentially 100% ethanol (199.5 proof). This anhydrous ethanol is now ready to be used for motor fuel purposes.

No centrifugation step is necessary at the end of the wet mill biochemical and/or biofuel production process 10 as the germ, fiber, and gluten have already been removed in the previous separation steps 16, 22 and 24. The “stillage” produced after distillation and dehydration 36 in the wet mill process 10 is often referred to as “whole stillage” although it also is technically not the same type of whole stillage produced with the dry grind process described in FIG. 2 below, since no insoluble solids are present. Other wet mill producers may refer to this type of stillage as “thin” stillage.

The wet grind process 10 can produce a high quality starch product for conversion to alcohol, as well as separate streams of germ, fiber, and protein, which can be sold as co-products to generate additional revenue streams. However, the overall yields for various co-products can be less than desirable; and the wet grind process is complicated and costly, requiring high capital investment as well as high-energy costs for operation.

Because the capital cost of wet grind mills can be so prohibitive, some alcohol plants prefer to use a simpler dry grind process. FIG. 2 is a flow diagram of a typical dry grind biochemical or biofuel production process 100, such as an alcohol (e.g., ethanol) production process. The process 100 begins with a milling step 102 in which dried whole corn kernels are passed through hammer mills in order to grind them into meal or a fine powder. The ground meal is mixed with water to create a slurry, and a commercial enzyme called alpha-amylase is added (not shown). This slurry is then heated to approximately 120° C. for about 0.5 to five (5) minutes in a pressurized jet cooking process 104 in order to gelatinize (solubilize) the starch in the ground meal. It is noted that some processes exclude a jet cooker and instead have a longer hold time of the slurry in a slurry tank at a temperature from about 50° C. to 95° C.

This is followed by a liquefaction step 106 at which point additional alpha-amylase may be added. The stream after this liquefaction step has about 30% dry solids (DS) content with all the components contained in the corn kernels, including sugars, protein, fiber, starch, germ, oil and salts. This is followed by separate saccharification and fermentation steps, 108 and 110, respectively, although in most commercial dry grind ethanol processes, saccharification and fermentation occur simultaneously. This step is referred to in the industry as “Simultaneous Saccharification and Fermentation” (SSF). Both saccharification and SSF can take as long as about 50 to 60 hours. Fermentation converts the sugar to alcohol. Yeast can optionally be recycled in a yeast recycling step 112. Subsequent to the fermentation step 110 is a distillation and dehydration step 114, much like that in the wet mill process, to recover the alcohol.

Finally, a centrifugation step 116 involves centrifuging the residuals produced with the distillation and dehydration step 114, i.e., “whole stillage” in order to separate the insoluble solids (“wet cake”) from the liquid (“thin stillage”). The liquid from the centrifuge contains about 8% to 10% DS. The thin stillage enters evaporators in an evaporation step 118 in order to boil away moisture, leaving a thick syrup which contains the soluble (dissolved) solids from the fermentation (25 to 35% dry solids). The concentrated slurry can be sent to a centrifuge to separate the oil from the syrup. The oil can be sold as a separate high value product. The oil yield is normally about 0.5 Lb/Bu of corn with high free fatty acids content. The free fatty acids are created when the oil is held in the fermenter for approximately 50 hours. The free fatty acids content reduces the value of the oil. The de-oil centrifuge only removes less than 50% because the protein and oil make an emulsion, which cannot be satisfactorily separated.

The syrup, which has more than 10% oil, can be mixed with the centrifuged wet cake, and the mixture may be sold to beef and dairy feedlots as Distillers Wet Grain with Solubles (DWGS). Alternatively, the wet cake and concentrated syrup mixture may be dried in a drying step 120 and sold as Distillers Dried Grain with Solubles (DDGS) to dairy and beef feedlots. This DDGS has all the protein and 75% of the oil in corn. But the value of DDGS is low due to the high percentage of fiber, and in some cases the oil is a hindrance to animal digestion.

Because the dry mill process 100 only produces ethanol and low value DDGS, many companies have started to develop a dry fraction process. In this process, corn goes through a pretreatment step, such as steam treatment, then various types of mechanical separation equipment are utilized to separate the dry fractions of the corn, including the fiber, starch, and oil/germ portion. While these separation processes accomplish some separation of the components, the separation is generally incomplete. For example, the fiber portion normally contains more than 30% starch on a dry basis, and the germ contains more than 25% starch and 35% oil content on a dry basis. In addition, less than 30% of the total oil in the corn kernels is recovered with these processes; and the germ and fiber portions must go through purification stages before they can be sold for a reasonable price.

After the dry fractionation, the starch (with protein) goes through another grind step, then liquefaction, fermentation, distillation, and evaporation to produce alcohol and syrup, much the same as in the dry grind process 100. But the alcohol yield normally is as low as 2.3 gal/Bu of corn because of the loss of starch to the germ and fiber portions. In addition, the purification steps mentioned above for the germ and fiber are complicated and costly. Notably, the dry fraction process does not give sharp separation and produces low purity co-products, which complicates the downstream purification steps. Because of the high costs and low yields, these dry fractionation processes have not been generally accepted by the industry.

Other attempts have been made in the dry grinding industry to desirably recover high value co-products, such as oil. However, attempts to separate oil from the “hammer milled” slurry have failed because of the high concentration of solids and because the oil is not released from the solid particles. Some success has been realized with processes recovering oil from the evaporation stages of the dry mill process. However, the yield is relatively low, and the oil must move through the entire process, including fermentation, prior to evaporation. The presence of the oil in these steps of the process can be detrimental to the efficiency of the remaining parts of the process. Attempts have been made to recover the oil directly after fermentation. However, the process of mixing and fermentation, coupled with low solids content, emulsifies the oil, and this makes it very difficult to remove. Other attempts have been made to recover oil directly from corn by solvent extraction but the cost, for example, is too high for commercial use.

It would thus be beneficial to provide an improved system and method for separating co-products from grains and/or grain components used for biochemical and/or biofuel production, such as alcohol production, that overcomes various aforementioned drawbacks, such as to produce high value co-products with desirable yield.

### SUMMARY OF THE INVENTION

The invention provides for an improved system and method for separating co-products, such as oil, from grains and/or grain components used for biochemical and/or biofuel production, such as alcohol (e.g., ethanol) production such as to produce high value co-products with desirable yield.

In one embodiment of the invention, a method is provided for separating co-products from grains and/or grain components used for biochemical and/or biofuel production, such as alcohol (e.g., ethanol) production, which includes subjecting milled grains and/or grain components used for biochemical and/or biofuel production to liquefaction to provide a liquefied starch solution including fiber, protein, germ, and free oil. Then, solids including fiber and germ are separated from the liquefied starch solution. Thereafter and prior to fermentation, the free oil is separated from the liquefied starch solution to yield an oil co-product wherein at least one of a surfactant or flocculent is added to the milled grains and/or grain components prior to or during liquefaction or to the liquefied starch solution prior to separating the oil.

In another embodiment of the invention, a method is provided for separating co-products from grains and/or grain components used for biochemical and/or biofuel production, such as alcohol (e.g., ethanol) production, which includes, in a corn dry-milling process for making a biochemical and/or biofuel, separating a whole stillage byproduct, via constituent particle sizes, into an insoluble solids portion and a thin stillage portion, which includes free oil and protein. Then, a lighter water soluble solids portion, which includes the oil, is separated out from heavier constituents, including the protein, in the thin stillage portion, via constituent weights. And the oil is separated from the water soluble solids portion to provide an oil portion wherein at least one of a surfactant or flocculent is added to the milled grains and/or grain components prior to or during liquefaction or to the liquefied starch solution prior to separating the oil.

The features and objectives of the present invention will become more readily apparent from the following Detailed Description taken in conjunction with the accompanying drawings.

### BRIEF DESCRIPTION OF THE DRAWINGS

The accompanying drawings, which are incorporated in and constitute a part of this specification, illustrate embodiments of the invention and, with a detailed description of the embodiments given below, serve to explain the principles of the invention.

FIG. 1 is a flow diagram of a typical wet mill biochemical or biofuel production process;

FIG. 2 is a flow diagram of a typical dry mill biochemical or biofuel production process;

FIG. 3 is a flow diagram of a system and method for separating high value co-products from grains and/or grain components used for biochemical and/or biofuel production in accordance with an embodiment of the invention;

FIG. 3A is a flow diagram of a variation of the system and method of FIG. 3;

FIG. 4 is a flow diagram of a system and method for separating high value co-products from grains and/or grain components used for biochemical and/or biofuel production in accordance with another embodiment of the invention;

FIG. 4A is a flow diagram of a variation of the system and method of FIG. 4;

FIG. 5 is a flow diagram of a system and method for separating high value co-products from grains and/or grain components used for biochemical and/or biofuel production in accordance with another embodiment of the invention;

FIG. 5A is a flow diagram of a variation of the system and method of FIG. 5;

FIG. 5B is a flow diagram of another variation of the system and method of FIG. 5; and

FIG. 6 is a flow diagram of a system and method for separating high value co-products from grains and/or grain components used for biochemical and/or biofuel production in accordance with another embodiment of the invention.

### DETAILED DESCRIPTION OF THE DRAWINGS

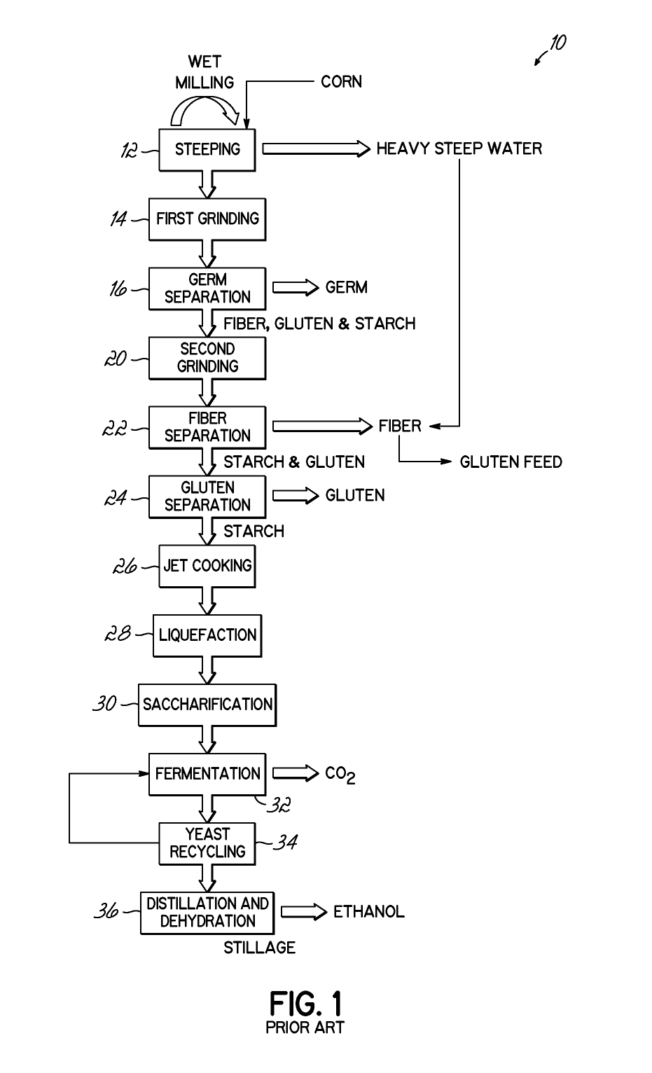

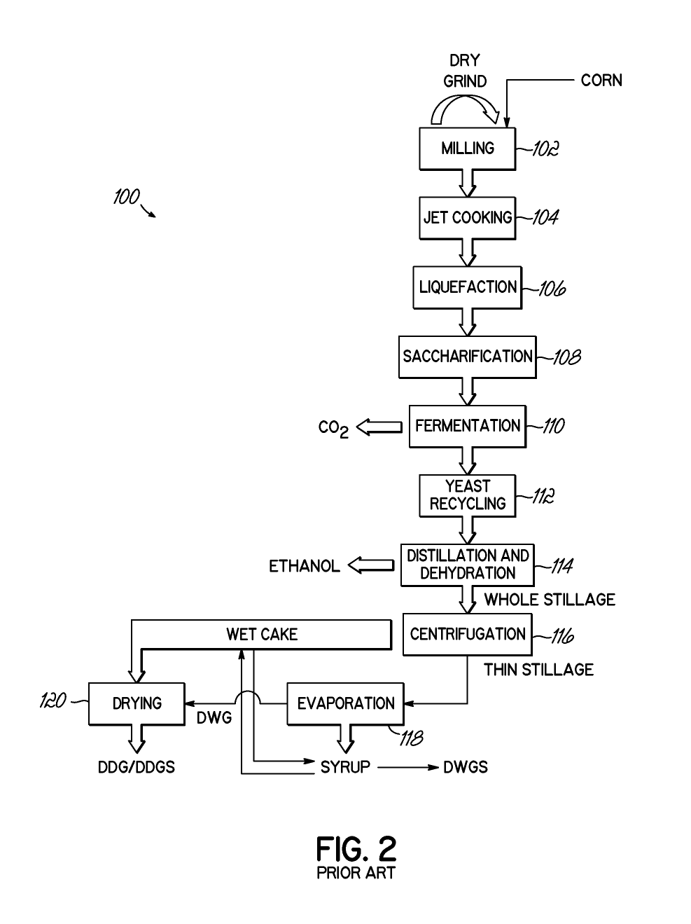

FIGS. 1 and 2 have been discussed above and represent flow diagrams of a typical wet mill and dry grind biochemical and/or biofuel production process, such as alcohol (e.g. ethanol) production, respectively.

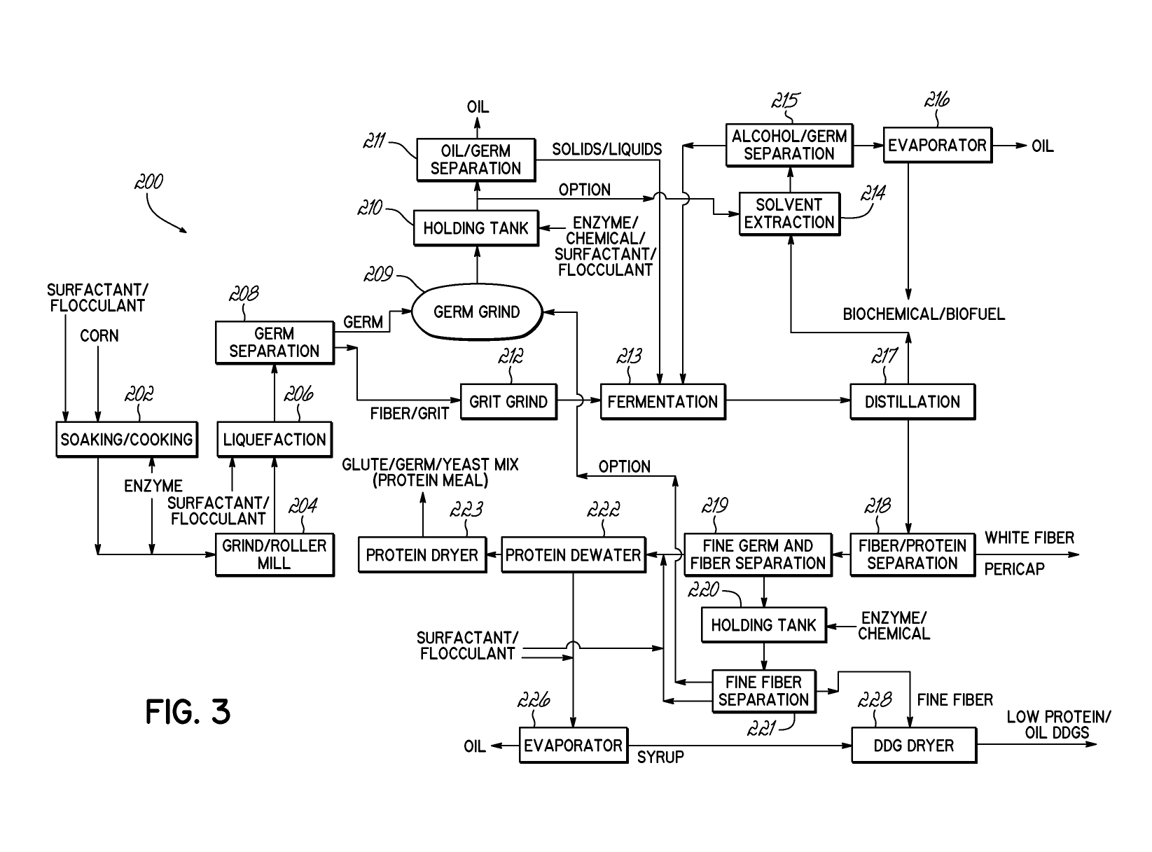

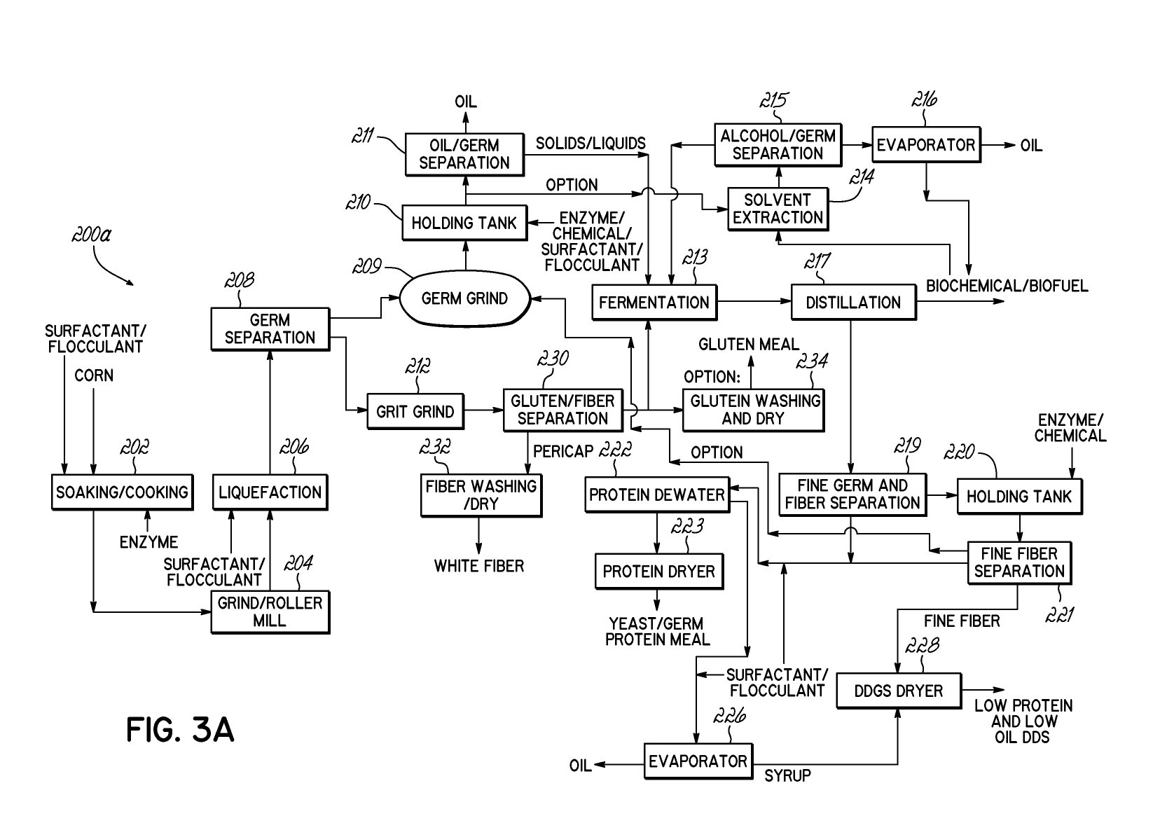

FIGS. 3-6 illustrate various embodiments of a system and method for separating high value co-products, such as oil, white fiber, and protein meal, from grains and/or grain components used for biochemical and/or biofuel production, such as alcohol (e.g., ethanol) production, which are improvements over the typical processes and others. These systems and methods are discussed in detail herein below.

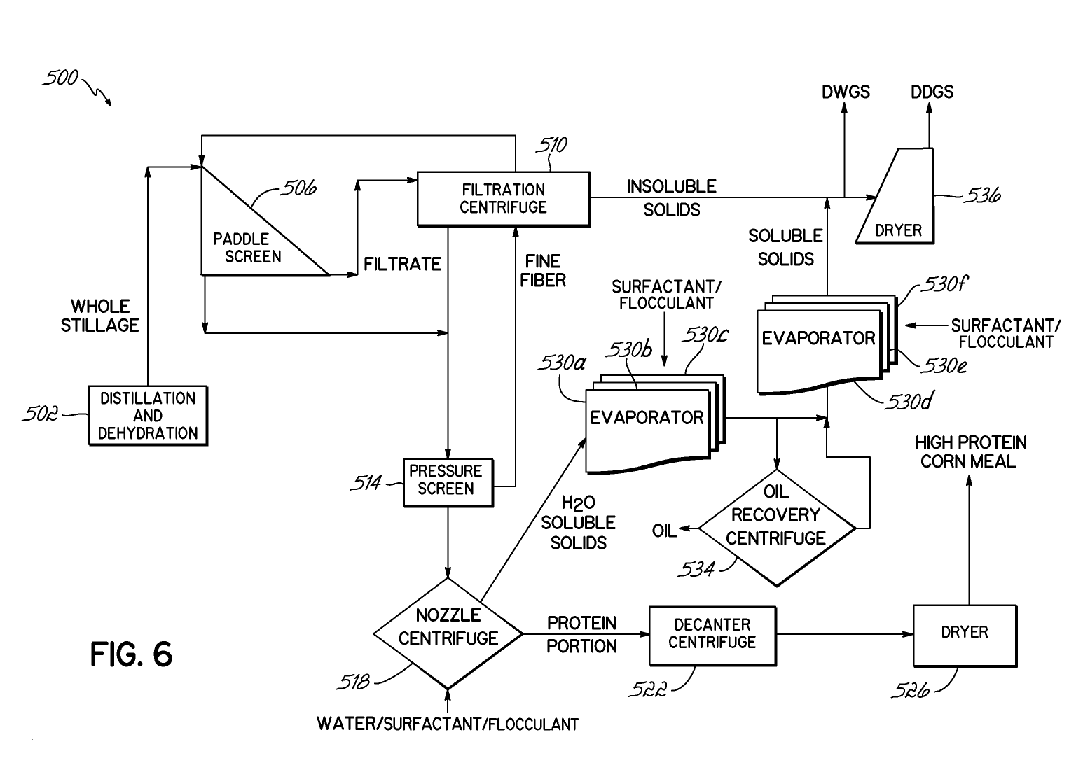

As an overview of the embodiments shown in FIGS. 3-5B, each system and process includes, after milling of the corn and prior to fermentation, separation of germ from a liquefied starch solution utilizing density differences between the different components in that solution. The liquefied starch solution after liquefaction contains oil, germ, grit, protein, and fiber particles with particle sizes ranging from less than 50 micron up to more than 2 mm. The density of oil typically is about 0.9 grams/cc, germ particle is about 1 grams/cc, and the grit, protein and fiber is about 1.1 to 1.15 grams/cc. The liquid solution during soaking/cooking and liquefaction has a density of about 1.05 to 1.12 grams/cc (e.g., about 15 to 28 Brix sugar solution). This heavy density of the liquefied starch solution can be utilized to separate germ and oil from grit, protein, and fiber. In addition, the pH of the slurry at liquefaction is about 5 to 6. FIG. 6 is discussed in detail further below.

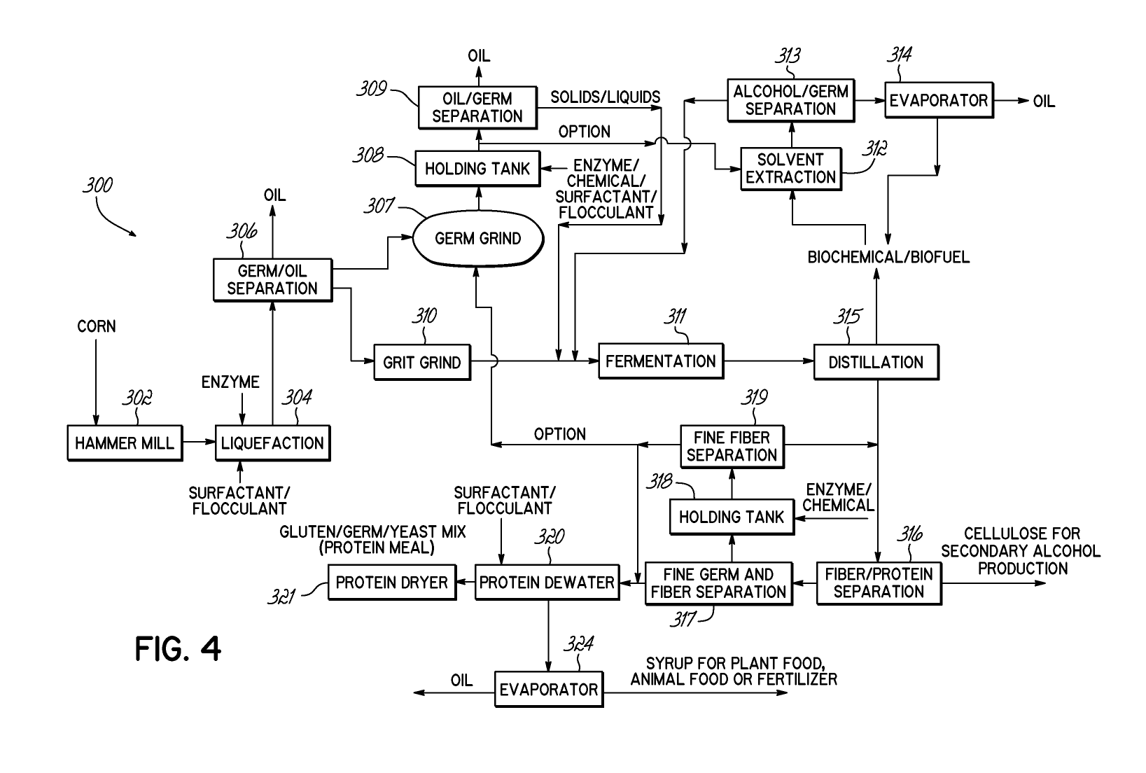

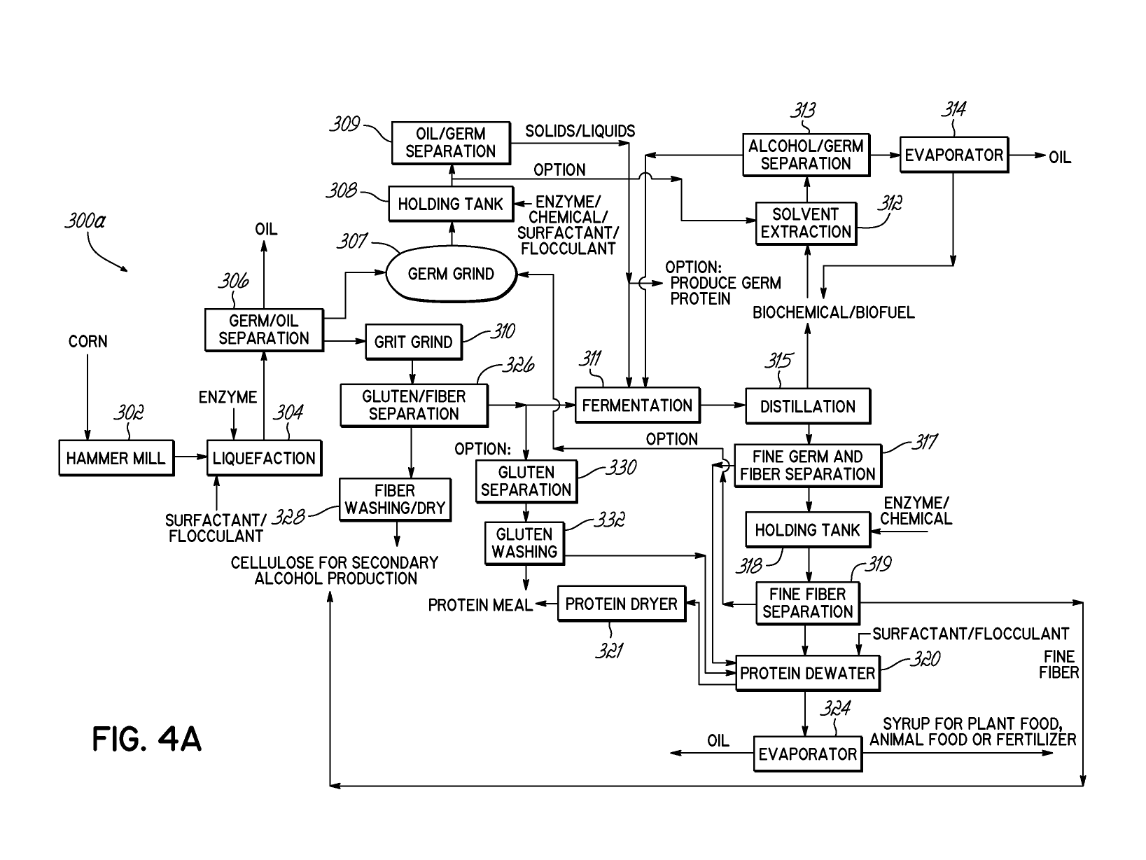

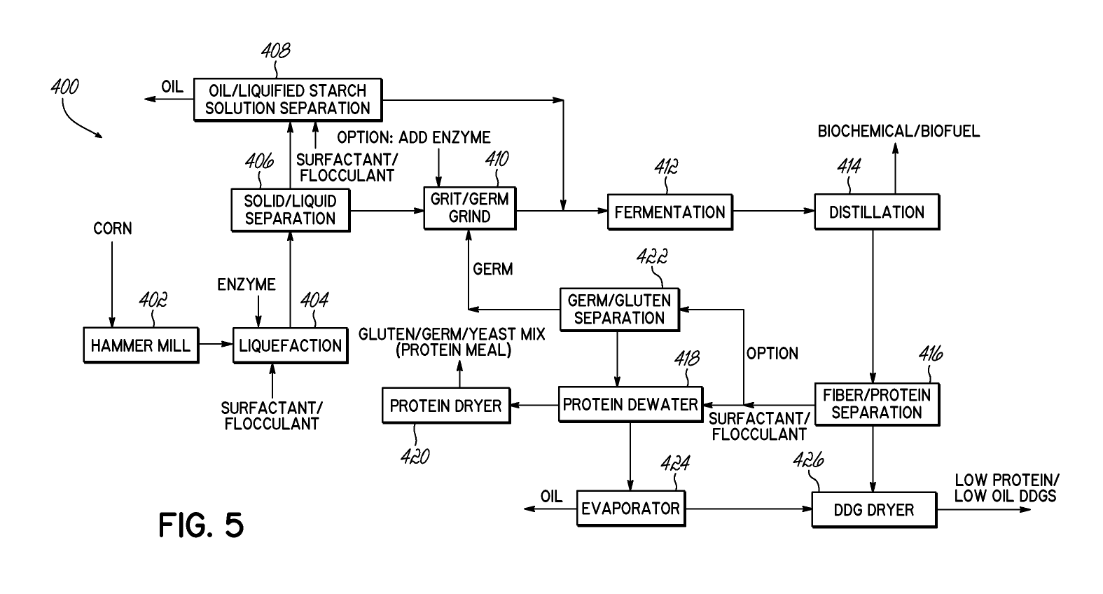

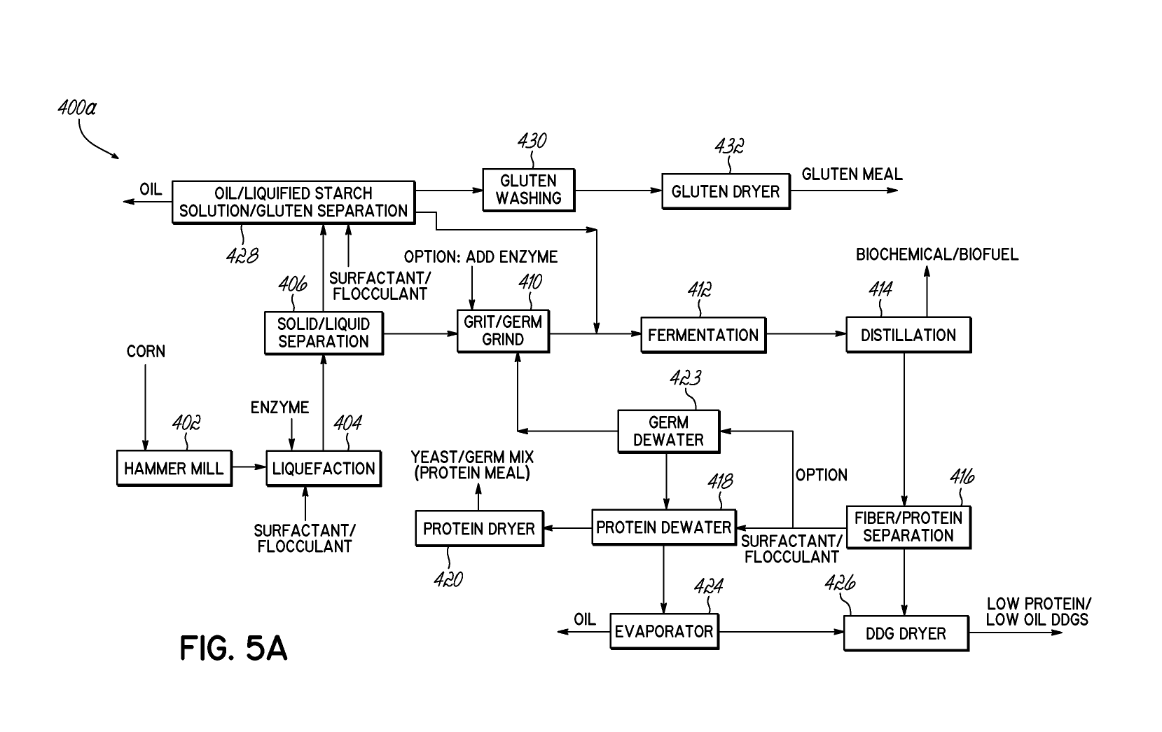

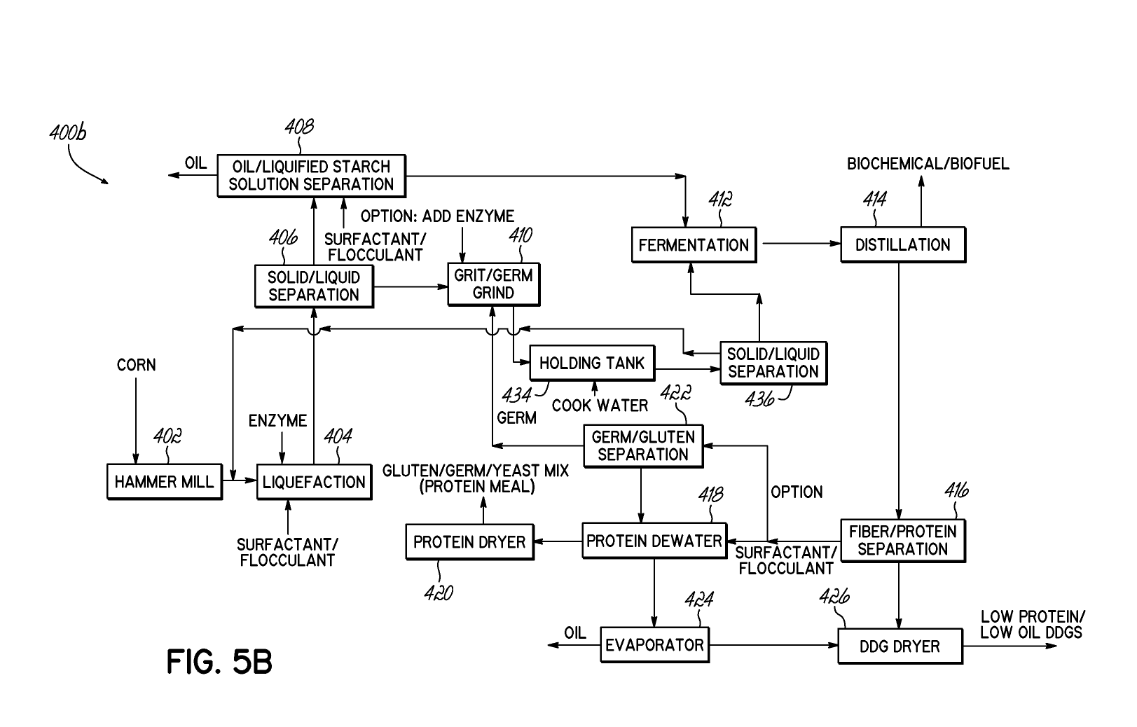

There are two general ways to prepare the germ prior to separation from the liquefied starch solution. The first way, as shown in FIGS. 3 and 3A, involves soaking and cooking the corn, then breaking the corn kernel by using a grind or roller mill followed by liquefaction. Alternatively, as shown in FIGS. 4-5B, the soaking and cooking step is eliminated, and much like the current existing dry grind process, the corn can be directly subjected to a hammer mill, for example, followed by liquefaction.

The grinding step is intended to break the germ and grit particles and the bonds between starch and protein, without cutting the fiber too fine. There are three types of fiber: (1) pericarp, with average particle sizes typically about 1 mm to 5 mm; (2) tipcap, with average particle sizes about 500 micron; (3) and fine fiber, with average particle sizes of about 250 micron. A filtration device, such as a fiber centrifuge, can be used to separate the different fiber types by relying on a screen(s) having different sized openings. The pericarp and tipcap are maintained at sizes larger than 300 microns, while the germ and grit are less than that size. Also, fine fiber can create downstream fiber/protein separation problems and can produce a very wet fiber (DDG) cake, which is too costly to dry. An enzyme(s), such as a cell wall degrading enzyme including amylase, protease, or combinations thereof, also can optionally be added during the grind/impact mill step, for example, to help break the bonds between protein, starch, and fiber. During or after soaking/cooking or liquefaction, the liquefied starch solution can go through several possible separation devices, such as a three-phase and/or a two-phase decanter or cyclone, to separate, for example, germ and oil therefrom, which can be further processed as more specifically discussed below, such as to produce a desirable oil and/or fiber co-product.

With reference now to FIG. 3, a system and method 200, which generally corresponds to a wet type system and process, is shown that separates co-products, such as high value germ and protein, from grains and/or grain components used for biochemical and/or biofuel production, such as alcohol (e.g. ethanol) production so as to yield, for example, desirable white fiber (e.g., pericarp) for industrial use and high value oil. In this specific system and method 200, the corn is subjected to a soaking/cooking step 202 whereat the corn is soaked for 4 to 12 hours in soaking tanks filled with water having a temperature around 55° C. to 95° C. An enzyme, such as alpha amylase, may optionally be included in the soaking tanks, as well as about 50 to 100 ppm of sodium sulfite, sulfur dioxide, or the like. The soaked corn then may be subjected to a grinding step 204 using one or more grind mills and/or roller mills to break the corn kernel and release the germ. An enzyme, such as alpha amylase, may optionally be added prior to or to the grinding step 204. Then, the slurry, which includes starch, is subjected to a liquefaction step 206, which provides a liquefied starch solution having a density of about 1.05 to 1.15 grams/cc. At the liquefaction step 206, the starch begins converting to a liquefied starch solution. Any suitable liquefaction apparatus, which is well known in the art, may be utilized here.

Next, the germ is separated at a germ separation step 208 from the liquefied starch solution, as well as from the fiber, protein, and grit, by taking advantage of density differences between the different components in the liquefied starch solution using, for example, a two-stage germ cyclone or a disc or decanter centrifuge designed therefore, in series. In particular, the liquefied starch solution is used as heavy media liquid to float the germ, which is subsequently separated therefrom. The germ is then fed to a grinding device at a grinding step 209 to fine grind the germ particles to a particle size less than 150 microns (or, in another example, less than 50 microns) without creating fine fiber and to release oil from the germ thereby providing an oil/germ mixture.

The ground germ (or oil/germ mixture) is transported to a germ holding tank 210 whereat the pH of the germ in the tank can be adjusted to about 8 to about 10.5 (or about 8 to about 9.5), such as by the addition of chemicals, e.g., sodium hydroxide, lime, sodium carbonate, trisodium phosphate, or the like, to help release oil from the germ. Also, cell wall breaking enzymes, e.g., protease and the like, and/or chemicals, e.g., sodium sulfite and the like, may be added here to help release oil from the germ. In one example, the germ can be held in the tank for about 1 hour at a temperature of about 140° F. to about 200° F. (or about 180° F. to about 200° F.).

The oil and fine germ mixture is next subjected to an oil/germ separation step 211 whereat the oil is separated from the fine germ by taking advantage of density differences between the different components in the residual liquefied starch solution using, for example, a three phase and/or a two-phase decanter or three phase and/or a two-phase disc centrifuge. The oil that is recovered at this stage in the process has a much more desirable quality in terms of color and free fatty acid content (from about 2% to about 5%) as compared to oil that is recovered downstream, particularly oil recovered after fermentation. In particular, the color of the pre-fermentation recovered oil is lighter in color and lower in free fatty acid content. The oil yield can include 1.0 lb/Bu or greater. In one example, the oil yield is from about 1.0 to about 1.2 lb/Bu. A surfactant and/or a flocculent can be added at and/or prior to step 208 to help improve oil yield recovery, for example. In addition to, or as an alternative to, the oil recovery efforts prior to fermentation, it also should be understood that similar oil recovery methods may be performed during and/or after fermentation.

The underflow liquefied starch solution from the germ separation step 208, which includes fiber, protein, and grit, is subjected to a size reduction step 212 using a grind mill, pin mill, or high pressure cooker, for example, to further breakdown the bond between the fiber, starch, and protein. Although not specifically shown, various enzymes (and types thereof) such as glucoamylase, fungal, cellulose, cellobiase, protease, and the like can be optionally added during the size reduction step 212 and thereafter, including during fermentation, to enhance the separation of components.

The solids, which include the separated fine germ (de-oiled), and residual liquefied starch solution from the oil/germ separation step 211 is joined back up with the liquefied starch solution from the size reduction step 212 at fermentation step 213. The fine germ can be separated out downstream as high value fine germ particle, from the fiber and protein components. In an alternate example, the separated germ that is sent to grind step 209 can be ground to a particle size less than 500 microns but not so small as to release oil from the germ and without creating fine fiber. In one example, the germ particle size is from 50 to 500 micron, with an average size of 250 micron. Thereafter, the fine germ particle can be returned to the liquefied starch solution after the size reduction step 212 and prior to the fermentation step 213 for separating out downstream as high value fine germ particle. In this alternate example, the germ holding tank 210 and oil/germ separation step 211 are removed from the method.

As an alternative, the oil/germ separation step 211 optionally may be replaced by a solvent extraction step 214, solvent/germ separation step 215, and solvent evaporation step 216 to recover oil from the oil and fine germ mixture at holding tank 210. In particular, the oil and fine germ mixture may be sent from the holding tank 210 to solvent extraction step 214 whereat recovered biochemical or biofuel, e.g., alcohol, from distillation step 217 is added to the oil and fine germ mixture to extract oil therefrom. The alcohol/oil/germ mixture is then sent to the solvent/germ separation step 215 to separate the alcohol, which includes the extracted oil, from the fine germ by using, for example, a decanter or disc centrifuge. The solids (or heavy phase), which include the separated fine germ (de-oiled), and residual liquefied starch solution from the solvent/germ separation step 215 is joined back up with the liquefied starch solution from the size reduction step 212 at fermentation step 213. And the separated alcohol/oil solution (or light phase) is sent to solvent evaporation step 216 whereat an evaporator separates the oil and biochemical or biofuel, e.g., alcohol, for recovery thereof. A small evaporator can be included as part of the distillation tower. The de-oiled germ normally has about 10% to 20% oil. But with the solvent extraction step 214, the de-oiled germ includes about 4% to 10% oil. The oil yield can include 1.0 lb/Bu or greater. In one example, the oil yield is from about 1.0 to about 1.4 lb/Bu (or from 1.2 to about 1.4 lb/Bu).

At fermentation step 213, the liquefied starch solution, which includes the fiber, protein, grit, and now the fine germ particle, is subjected to fermentation followed by distillation at distillation step 217. The fine germ will partially de-oil during fermentation, which can aid in the later separation and production of a high value oil having reduced or no germ protein.

The fiber can be separated from the fine germ particles, fine fiber, and protein (gluten) at a fiber/protein separation step 218 by differences in particle sizes using a screen device, such as a paddle screen/filtration centrifuge, to remove white fiber, i.e., the pericarp, therefrom. Here, the screen openings normally will be about 1 mm in size, but can range from about 0.3 mm to 1.5 mm. Further concerning particle sizes, the average particle size for protein is about 1 to 5 microns, the fine germ is about 10 to 500 microns, and the various fibers range from about 50 micron to 3 mm size. The separated fiber is washed and dried to produce high value white fiber for industrial, feed, food, pharmaceutical, and/or nutraceutical use, with a yield of about 2 lb/Bu. The separated fiber can also be used as a feed stock for secondary alcohol production at a yield of about 3 lb/Bu. The white fiber is mainly from pericarp and contains less than 10% protein, less than 2% oil, and less than 2% starch. In one example, the white fiber includes 85% or more pericarp, in another example, 90% or more pericarp, and in another example, 95% or more pericarp.

With continuing reference to FIG. 3, the filtrate from the filtration centrifuge, which includes residual fine fiber and tipcap having sizes of about 30 microns to 300 microns and about 300 microns to 500 microns, as well as fine germ and gluten (protein), moves to a fine germ and fiber separation step 219 whereat fine germ and fine fiber are removed from the gluten solution by a fine screen device, such as paddle screen or pressure screen with a screen size of about 45 micron. The fine germ and fine fiber are transported to a fine germ/fiber holding tank 220 whereat the pH of the fine germ/fiber in the tank can be adjusted to about 8 to about 10.5 (or about 8 to about 9.5), such as by the addition of chemicals, e.g., sodium hydroxide, lime, sodium carbonate, trisodium phosphate, or the like, to help release additional oil from the germ. Also, cell wall breaking enzymes, e.g., protease and the like, and/or chemicals, e.g., sodium sulfite and the like, may be added here to help release additional oil from the germ. The fine germ and fiber mixture is next subjected to a fine fiber separation step 221 whereat the fine fiber is separated from the fine germ by a decanter, for example, and then dried to yield DDG. In one example, the fine fiber includes less than 15% protein and 4% oil.

The centrate from the fine germ and fiber separation step 219 and the centrate from fine fiber separation step 221 is joined back up and goes to a protein recovery/dewatering step 222, which uses, for example, a decanter, a nozzle centrifuge, or a disc decanter to recover the fine germ and protein (as well as spent yeast). Alternatively, the centrate from the fine fiber separation step 221 instead may be optionally dewatered using, for example, a decanter, a nozzle centrifuge, or a disc decanter and sent back to germ grind step 209 to extract more oil. The components from the recovery/dewatering step 222 are sent to a dryer 223 to yield a high value gluten/germ/yeast mix (protein meal) having about 50% gluten and about 30% germ/yeast, with the balance mostly fiber. The underflow from the protein dewatering step 222 goes to an evaporator 226 to separate any additional oil therefrom and to produce syrup, which can be mixed with the DDG and dried, as represented by numeral 228, to give a low protein (about 20%)/low oil (about 7%) DDGS, such as for cows or pigs. In one example, the protein is no greater than 20% and the oil is no greater than 7%. In another example, sodium sulfite, sulfur dioxide, or the like may be added at any step in the process between the soaking/cooking step 202 and drying step 228. Notably, in this system and method 200, most of the co-product is recovered after fermentation.

With respect to the oil recovery, whenever there is oil recovery, there generally tends to be an emulsion layer formed in the collection tanks. In the tanks where the oil is stored, the oil naturally floats and the emulsion layer sits towards the interface with any solids. There is a significant xanthophyll content in the emulsion layer, and this is good for making chicken egg yolks and skin yellow, as well as a natural food colorant agent. With an optional centrifugation step (not shown), the xanthophyll content in the emulsion layer can be recovered and mixed with the protein meal co-product prior to protein drying to increase the feed value. Sodium sulfite, sulfur dioxide, or the like may be added to the wet protein cake, for example, to maintain more than a 20 ppm sulfur dioxide level before the wet protein cake is sent to the protein dryer 223. The sulfur dioxide can prevent the xanthophylls from decomposing inside the protein dryer 223. The oil (light phase) from the centrifuge can go back to the oil storage tank(s). Optionally, the emulsion layer can be used as a separate feed source for further processing to remove the xanthophyll. This can be achieved (not shown here) by solvent extraction, separation, and drying of the xanthophyll. The solvent may be of a hydrocarbon (nature or water-based) to sufficiently separate the xanthophyll.

With reference now to FIG. 3A, this figure depicts a flow diagram of a variation of the system and method 200 of FIG. 3. In this system and method 200a, gluten (protein) meal and white fiber (i.e., pericarp) can be removed prior to fermentation 213. Briefly, by way of background, it is noted that there are 100 to 200 mg/lb of xanthophyll in gluten meal from a typical corn wet mill process. Recovery of the gluten meal before fermentation 213 can cut down on xanthophyll loss during fermentation 213 and subsequent distillation and protein recovery steps 217, 222. In addition, it is noted that the particle size of the pericarp is important for food or industrial uses, such as those in the paper industry. Larger size pericarp particles, such as from about 1 to about 5 mm, can plug a heat exchanger used during fermentation. So removal of the pericarp before fermentation 213 can avoid these plugging problems and can increase fermentation capacity by about 15% due to the early removal of the pericarp.

As shown in FIG. 3A, after germ separation and the subsequent size reduction step 212, the liquefied starch solution along with the fiber, protein, and grit is subjected to a gluten/fiber separation step 230 using a screen device, such as a filtration centrifuge, to remove white fiber, i.e., the pericarp, therefrom. The screen openings normally will be about 1.5 mm in size, but can range from about 1 mm to about 2 mm. The separated fiber is washed and dried, as represented by numeral 232, to produce high value white fiber for industrial use, with a yield of about 2 lb/Bu. The separated fiber can also be used as a feed stock for secondary alcohol production. For white fiber used as a feedstock for the paper industry, for example, the fiber is mainly from pericarp whereas for secondary alcohol production, the fiber is mainly pericarp, tip cap, and fine fiber, and has a yield of 3 to 4 lb/Bu, and contains less than 14% protein and less than 5% oil. In one example, the white fiber includes 85% or more pericarp, in another example, 90% or more pericarp, and in another example, 95% or more pericarp.

The protein in the liquefied starch solution overflow from the gluten/fiber separation step 230 can optionally be separated out by methods known in the art wherein the gluten moves to a washing and drying step 234 to yield a high value gluten meal having a desirable percentage of xanthopyll, i.e., from about 100 mg/Lb to about 200 mg/Lb. Otherwise, the liquefied starch solution overflow portion meets up with the fine germ particles at the fermentation step 213. The remainder of the process is generally the same as that of FIG. 3, with the exception that the gluten meal and white fiber have been recovered on the front of the process, prior to fermentation 213. In particular, where the white fiber was previously separated from the protein, fine fiber, and fine germ particles and recovered in the system and method 200 of FIG. 3, fine fiber and fine germ having a size larger than 50 microns are separated from residual protein (gluten) at the fine germ and fiber separation step 219 using a fine screen device, such as paddle screen or pressure screen with a screen size of about 45 micron.

The fine germ and fine fiber are then transported to the fine germ/fine fiber holding tank 220 whereat the pH of the fine germ/fiber in the tank can be adjusted to about 8 to about 10.5 (or about 8 to about 9.5), such as by the addition of chemicals, e.g., sodium hydroxide, lime, sodium carbonate, trisodium phosphate, or the like, to help release oil from the germ. Also, cell wall breaking enzymes, e.g., protease and the like, and/or chemicals, e.g., sodium sulfite and the like, may be added here to help release oil from the germ. The germ and fiber mixture is next subjected to fine fiber separation step 221 whereat the fine fiber is separated from the fine germ by a decanter, for example, and then dried to yield DDG. In one example, the fine fiber includes less than 15% protein and 4% oil so as to yield DDG. The centrate from the fine germ and fiber separation step 219 and the centrate from the fine fiber separation step 221 is joined back up and goes to protein recovery/dewatering step 222, which uses, for example, a decanter, a nozzle centrifuge, or a disc decanter to recover the fine germ and residual protein, as well as spent yeast. Alternatively, the centrate from the fine fiber separation step 221 instead may be optionally dewatered using, for example, a decanter, a nozzle centrifuge, or a disc decanter and sent back to germ grind step 209 to extract more oil. The components from the protein recovery/dewatering step 222 are sent to the dryer 223 to yield primarily a germ/yeast mix having about 60% gluten and about 40% germ/yeast.

With reference now to FIG. 4, this figure depicts a flow diagram of another embodiment of a system and method 300 for separating high value co-products from grains and/or grain components used for biochemical and/or biofuel production, e.g., alcohol production. This system and method 300, which generally corresponds to a dry grind alcohol (e.g., alcohol) production system and process, separates various co-products to yield, for example, cellulosic material for secondary production and high value oil. To that end, in this specific process and method 300, the corn is first subjected to a hammer mill 302, for example, which can be used to grind the corn to particle sizes less than about 7/64 inch and assisting in the release of oil therefrom. In one example, the particle size is from about 50 micron to 3 mm. The grinding helps break up the bonds between the fiber, protein, starch, and germ. In another example, a germ fraction, such as from a dry fraction process, may replace the initially un-ground corn here. The ground corn is mixed with water and sent to a liquefaction step 304, which provides a liquefied starch solution having a density of about 1.05 to 1.15 grams/cc. At the liquefaction step 304, the starch begins converting to a liquefied starch solution. An enzyme(s), such as alpha amylase, can be added to the liquefaction step 304. Any suitable liquefaction apparatus, which is well known in the art, may be utilized here.

The stream from the liquefaction step 304 contains about 1 lb/Bu free oil and about 1.5 lb/Bu germ particle (size ranges from less about 50 micron to about 1 mm), 1 lb/Bu grit (size ranges from about 50 micron to about 1 mm), and 5 lb/Bu fiber (particle size ranges from about 50 micron to about 3 mm). This stream goes to a germ/oil separation step 306, which uses three-phase separation equipment (e.g., a three-phase decanter, a three-phase disc centrifuge, a hydrocyclone, and the like), to individually separate oil and germ from the liquefied starch solution, which includes heavier fiber, protein, and grit, by taking advantage of density differences between the different components in the liquefied starch solution. In particular, the liquefied starch solution is used as heavy media liquid to float the germ and oil, which have densities of about 1.0 to 1.05 grams/cc and 0.9 to 0.92 grams/cc, respectively. It is noted here that if a three-phase disc centrifuge is utilized at germ/oil separation step 306, a pre-screening step (not shown) to remove large sized fiber particles, such as >750 micron, for example, may be required. If this pre-screening step is utilized, the solids portion bypasses the germ/oil step separation step 306 and goes directly to a grinding step 310, which is discussed further below. The oil that is recovered at this stage in the process, i.e., at germ/oil step separation step 306, has a much more desirable quality in terms of color and free fatty acid content (from about 2% to about 5%) as compared to oil that is recovered downstream, particularly oil recovered after fermentation. In particular, the color of the pre-fermentation recovered oil is lighter in color and lower in free fatty acid content. The oil yield can include 1.0 lb/Bu or greater. In one example, the oil yield is from about 1.0 to about 1.2 lb/Bu. A surfactant and/or a flocculent can be added at and/or prior to step 306 to help improve oil yield recovery, for example.

The separated germ is then fed to a grinding device at a grinding step 307 to fine grind the germ particles to a particle size between about 10 to 300 microns to help release additional oil thereby providing an oil/germ mixture. In another example, the particle size is less than 50 microns. The ground germ (or oil/germ mixture) is transported to a germ holding tank 308 whereat the pH of the fine germ can be adjusted to about 8 to about 10.5 (or about 8 to about 9.5), such as by the addition of chemicals, e.g., sodium hydroxide, lime, sodium carbonate, trisodium phosphate, or the like, to help release oil from the germ. Also, cell wall breaking enzymes, e.g., protease and the like, and/or chemicals, e.g., sodium sulfite and the like, may be added here to help release oil from the germ. In one example, the fine germ can be held in the tank for about 1 hour at a temperature of about 140° F. to about 200° F. (or about 180° F. to about 200° F.).

The oil and germ mixture is next subjected to an oil/germ separation step 309 whereat the oil is separated from the germ by taking advantage of density differences between the different components in the residual liquefied starch solution using, for example, a three phase decanter or three phase disc centrifuge. The oil that is recovered at this stage in the process has a much more desirable quality in terms of color and free fatty acid content (from about 2% to about 5%) as compared to oil that is recovered downstream, particularly oil recovered after fermentation. In addition to, or as an alternative to, the oil recovery efforts prior to fermentation, it also should be understood that similar oil recovery methods may be performed after fermentation.

The underflow liquefied starch solution from the germ separation step 306, which includes fiber, protein, and grit, goes through a grinding step 310, such as a grind mill, to further breakdown the bond between the fiber, starch, and protein. Although not specifically shown, various enzymes (and types thereof) such as glucoamylase, fungal, cellulose, cellobiase, protease, and the like can be optionally added during the grind step 310 and thereafter, including during fermentation, to enhance the separation of components.

The solids, which include the separated fine germ, and residual liquefied starch solution from the oil/germ separation step 309 is joined back up with the liquefied starch solution from the size reduction step 310, then subjected to fermentation step 311. The fine germ particle can be separated out downstream as high value fine germ particle (partially de-oiled), from the fiber and protein components. In an alternate example, the separated germ is sent to grinding step 310 and, thereafter, the fine germ particle can be returned to the liquefied starch solution after the size reduction step 310 at fermentation step 311 for separating out downstream as high value fine germ particle. In this alternate example, the germ holding tank 308 and oil/germ separation step 309 are removed from the method.

As an alternative, the oil/germ separation step 309 optionally may be replaced by a solvent extraction step 312, solvent/germ separation step 313, and solvent evaporation step 314 to recover oil from the oil and fine germ mixture at holding tank 308. In particular, the oil and fine germ mixture may be sent from the holding tank 308 to solvent extraction step 312 whereat recovered biochemical or biofuel, e.g., alcohol, from distillation step 315 is added to the oil and fine germ mixture to extract oil therefrom. The alcohol/oil/germ mixture is then sent to the solvent/germ separation step 313 to separate the biochemical or biofuel, e.g., alcohol, which includes the extracted oil, from the fine germ by using, for example, a decanter or disc centrifuge. The solids (or heavy phase), which include the separated fine germ (de-oiled), and residual liquefied starch solution from the solvent/germ separation step 313 is joined back up with the liquefied starch solution from the size reduction step 310 at fermentation step 311. And the separated alcohol/oil solution (or light phase) is sent to solvent evaporation step 314 whereat an evaporator separates the oil and biochemical or biofuel, e.g., alcohol, for recovery thereof. A small evaporator can be included as part of the distillation tower. The de-oiled germ normally has about 10% to 20% oil. But with the solvent extraction step 312, the de-oiled germ includes about 4% to 10% oil. The oil yield can include 1.0 lb/Bu or greater. In one example, the oil yield is from about 1.0 to about 1.4 lb/Bu (or from 1.2 to about 1.4 lb/Bu).

At fermentation step 311, the liquefied starch solution, which includes the fiber, protein, grit, and now the fine germ particle, is subjected to fermentation followed by distillation at distillation step 315. At the distillation tower, the fermented solution (also referred to as beer) is separated from the stillage, which includes fiber, protein, and fine germ particles, to produce alcohol. The fiber can be separated from the fine germ particles and protein (gluten) at a fiber/protein separation step 316 by differences in particle sizes using a screen device, such as a paddle screen, filtration centrifuge, or decanter, to remove the fiber therefrom. The screen openings normally will be about 500 microns to capture amounts of tipcap, pericarp, as well as fine fiber, but can range from about 300 micron to about 700 micron. The separated fiber is washed and optionally dried to produce a cellulose for secondary alcohol production, which is a lower quality fiber than the white fiber produced by the process of FIG. 3, for example. The resulting cellulosic material, which includes pericarp and tipcap (and can include fine fiber) and has less than about 15% protein, less than about 5% oil, and less than about 4% starch, can be sent to a secondary alcohol system, as is known in the art, as feed stock without any further treatment.

With continuing reference to FIG. 4, the centrate from the fiber/protein separation step 316, which includes residual fine fiber and tipcap having sizes of 30 microns to 300 microns and 300 microns to 500 microns, as well as fine germ and gluten, moves to a fine germ and fiber separation step 317 whereat fine germ and fine fiber are removed from the gluten solution by a fine screen device, such as paddle screen or pressure screen with a screen size of about 45 micron. The fine germ and fine fiber are transported to a fine germ/fiber holding tank 318 whereat the pH of the fine germ/fiber in the tank can be adjusted to about 8 to about 10.5 (or about 8 to about 9.5), such as by the addition of chemicals, e.g., sodium hydroxide, lime, sodium carbonate, trisodium phosphate, or the like, to help release additional oil from the germ. Also, cell wall breaking enzymes, e.g., protease and the like, and/or chemicals, e.g., sodium sulfite and the like, may be added here to help release additional oil from the germ. The germ and fiber mixture is next subjected to a fine fiber separation step 319 whereat the fine fiber is separated from the fine germ by a decanter, for example. The fine fiber is recombined with the stillage from distillation so that is may again be subjected to fiber/protein separation step 316.

The centrate from the fine germ and fiber separation step 317 and the overflow from fine fiber separation step 319 is joined back up and goes to a protein recovery/dewatering step 320, which uses, for example, a decanter, a nozzle centrifuge, or a disc decanter to recover the fine germ and protein (as well as spent yeast). Alternatively, the overflow from the fine fiber separation step 319 instead may be optionally dewatered using, for example, a decanter, a nozzle centrifuge, or a disc decanter and sent back to germ grind step 310 to extract more oil. The components from the recovery/dewatering step 320 are sent to a dryer 321 to yield a high value gluten/germ/yeast mix (protein meal) having about 60% gluten and about 40% germ/yeast. The overflow from the protein dewatering step goes to an evaporator 324 to separate any oil therefrom and to produce a high concentrated syrup (more than 65% DS), which can be used, amongst other things, as (a) nutrition for secondary alcohol production, (b) animal feed stock, (c) plant food, (d) fertilizer, (e) and/or anaerobic digestion to produce biogas.

In addition, an optional centrifugation step (not shown) may be provided to recover the xanthophyll content in the emulsion layer of the recovered oils, both prior to and after fermentation 311, and mixed with the protein meal co-product prior to protein drying to increase the feed value. Sodium sulfite, sulfur dioxide, or the like may be added to the wet protein cake, for example, to maintain more than a 20 ppm sulfur dioxide level before the wet protein cake is sent to the protein dryer 321. The sulfur dioxide can prevent the xanthophylls from decomposing inside the protein dryer 321. The overflow from the centrifuge(s) can go back to the oil storage tanks.

With reference now to FIG. 4A, this figure depicts a flow diagram of a variation of the system and method 300 of FIG. 4. In this system and method 300a, the cellulosic material and the gluten (protein) meal can be removed prior to fermentation 311. Recovery of the gluten meal before fermentation 311 can cut down on xanthophyll loss during fermentation 311 and subsequent distillation and protein recovery steps 315, 320. In addition, larger size pericarp particles, such as from about 1 mm to about 4 mm, can plug heat exchangers used during fermentation 311. So removal of the pericarp before fermentation 311 can avoid these plugging problems and can increase fermentation capacity by about 15% over conventional processes.

As shown in FIG. 4A, after the germ/oil separation step 306, the liquefied starch solution along with the grit, fiber, and protein is subjected to the grinding step 310 followed by a gluten/fiber separation step 326 using a screen device, such as a filtration centrifuge, to remove the fiber therefrom. The screen openings normally will be about 500 microns to capture amounts of tipcap, pericarp, as well as fine fiber, but can range from about 300 micron to about 700 micron. The separated fiber is washed and optionally dried, as represented by numeral 328, to produce a cellulose for secondary alcohol production. The resulting cellulosic material, which includes pericarp and tipcap and has up to about 15% protein, up to about 5% oil, and up to about 4% starch, can be sent to a secondary alcohol system as feed stock without any further treatment.

The protein portion from the liquefied starch solution centrate after gluten/fiber separation step 326 can optionally be separated out, as represented by numeral 330, using a centrifuge, such as a disc decanter, or a nozzle centrifuge/decanter combination. The separated protein is further subjected to a washing step 332 and can yield a high value protein meal having a desirable percentage of xanthopyll, i.e., from about 100 mg/Lb to about 200 mg/Lb, which can be further combined with residual protein that is separated out downstream as discussed in detail further below. Otherwise, the liquefied starch solution centrate portion meets up with the fine germ particles at the fermentation step 311. As another option, the fine germ particles from the oil/germ separation step 309 can be further processed to separate out and produce germ protein prior to joining up with the liquefied starch solution at the fermentation step 311.

The remainder of the process is generally the same as that of FIG. 4, with the exception that the gluten meal and fiber have been recovered on the front end of the process prior to fermentation 311. In particular, where the fiber was previously separated from the protein, fine germ particles and fine fiber, there is now no such separation step 316 (FIG. 4). Instead, fine fiber and fine germ having a size larger than 50 microns are separated from residual protein (gluten) at fine germ and fiber separation step 317. Here, the fine germ and fine fiber are separated using a fine screen device, such as paddle screen or pressure screen with a screen size of about 45 micron.

The fine germ and fine fiber are transported to a fine germ/fine fiber holding tank 318 whereat the pH of the fine germ/fiber in the tank can be adjusted to about 8 to about 10.5 (or about 8 to about 9.5), such as by the addition of chemicals, e.g., sodium hydroxide, lime, sodium carbonate, trisodium phosphate, or the like to help release additional oil from the germ. Also, cell wall breaking enzymes, e.g., protease and the like, and/or chemicals, e.g., sodium sulfite and the like, may be added here to help release additional oil from the germ. The germ and fiber mixture is next subjected to a fine fiber separation step 319 whereat the fine fiber is separated from the fine germ by a decanter, for example. The fine fiber then can be combined with the separated fiber that has been washed and optionally dried, as represented by numeral 328, for producing the cellulose for secondary alcohol production. In one example, the fine fiber includes less than 15% protein and 4% oil.

The centrate from the fine germ and fiber separation step 317, the overflow from the fine fiber separation step 319, and the overflow from the optional front end gluten washing step 332 is joined up at protein recovery/dewatering step 320, which uses, for example, a decanter, a nozzle centrifuge, or a disc decanter to recover the fine germ and protein (as well as spent yeast). Alternatively, the overflow from the fine fiber separation step 319 instead may be optionally dewatered using, for example, a decanter, a nozzle centrifuge, or a disc decanter and sent back to germ grind step 307 to extract more oil. The components from the recovery/dewatering step 320 are sent to the dryer 321 and combined with the optionally separated gluten from the front end to yield a gluten/germ/yeast mix (protein meal) having about 60% gluten and about 40% germ/yeast. The overflow from the protein dewatering step 320 goes to the evaporator 324 to separate any oil therefrom and to produce the high concentrated syrup (more than 65% DS), which again can be used, amongst other things, as (a) nutrition for secondary alcohol production, (b) animal feed stock, (c) plant food, (d) fertilizer, (e) and/or anaerobic digestion to produce biogas.

With reference now to FIG. 5, this figure depicts a flow diagram of another embodiment of a system and method 400 for separating high value co-products from grains and/or grain components used for biochemical and/or biofuel production, e.g., alcohol production. This system and method 400, which generally corresponds to a dry grind alcohol (e.g., ethanol) production system and process, separates various co-products to yield, for example, a low protein (less than 20%)/low oil (less than 8%) DDGS, such as for cows or pigs and high value oil. To that end, in this specific process and method 400, the corn is first subjected to a hammer mill 402, for example, which can be used to grind the corn to particle sizes less than about 7/64 inch assisting in the release of oil therefrom. In one example, the particle size is from 50 microns to 3 mm. The grinding helps break up the bonds between the fiber, protein, starch, and germ. In another example, a germ fraction, such as from a dry fraction process, may replace the initially un-ground corn here. The ground corn is mixed with water and sent to a liquefaction step 404, which provides a liquefied starch solution having a density of about 1.05 to 1.15 grams/cc. At the liquefaction step 404, the starch begins converting to a liquefied starch solution. An enzyme(s), such as alpha amylase, can be added to the liquefaction step 404. Any suitable liquefaction apparatus, which is well known in the art, may be utilized here.

The stream from the liquefaction step 404 contains about 1 lb/Bu free oil and about 1.5 lb/Bu germ particle (size ranges from less about 50 micron to about 1 mm), 1 lb/Bu grit (size ranges from about 50 micron to about 1 mm), and 5 lb/Bu fiber (particle size ranges from about 50 micron to about 3 mm). This stream goes to a solid/liquid separation step 406, which uses any suitable filtration device, e.g., a pre-concentrator, paddle screen, pressure screen, fiber centrifuge, and the like, to separate the liquid from the solid material. The screen openings can range from about 50 micron to about 500 micron and will be selected to desirably separate the fiber, grit, and germ particles from the liquid, which primarily includes the liquefied starch solution with small amounts of oil, free protein (mainly gluten), and starch. In one example, the screen openings are about 50 micron.

The liquid portion can go to an oil/liquefied starch separation step 408 whereat the liquid portion is subjected to a centrifuge, such as a disc centrifuge, to separate the oil out before sending the liquefied starch solution to meet up with the treated solids portion prior to fermentation, which is discussed below. At oil/liquefied starch separation step 408, the liquefied starch solution is used as heavy media liquid to float the oil, which has a density of about 1.05 to 1.15 grams/cc. The oil that is recovered at this stage in the process has a much more desirable quality in terms of color and free fatty acid content (from about 2% to about 5%) as compared to oil that is recovered downstream, particularly oil recovered after fermentation. In particular, the color of the pre-fermentation recovered oil is lighter in color and lower in free fatty acid content. The oil yield can include 0.8 lb/Bu or greater. In one example, the oil yield is from about 0.8 to about 1.0 lb/Bu. A surfactant and/or a flocculent can be added at and/or prior to step 408 to help improve oil yield recovery, for example.

The separated solids portion from the solid/liquid separation step 406 is subjected to a size reduction step 410 using a grind mill, pin mill, or high pressure cooker step, for example, to further breakdown the bond between the fiber, starch, and protein. Various enzymes (and types thereof) such as glucoamylase, fungal, cellulose, cellobiase, protease, and the like also can be optionally added to enhance the separation. The treated solids portion from the size reduction step 410 and the liquefied starch solution from the oil/liquefied starch separation step 408 are then combined together. The liquefied starch solution, which now includes the fiber, grit, germ, and protein, is subjected to a fermentation step 412 followed by distillation 414. At the distillation tower, the fermented solution is separated from the stillage, which includes fiber, protein, and germ particles, to produce alcohol. The fiber can be separated from the germ particles and protein (gluten) at a fiber/protein separation step 416 by differences in particle sizes using a screen device, such as a filtration centrifuge, to remove the fiber therefrom. The screen openings normally will be about 500 microns to capture amounts of tipcap, pericarp, as well as fine fiber, but can range from about 300 micron to about 700 micron. The separated fiber is used to produce a low protein (less than 20%)/low oil (less than 8%) DDG.

If a lower protein and oil content in the fiber is needed or desired, the fiber may be sent to a holding tank (not shown), for example, whereat the pH of the separated fiber can be adjusted to about 8 to about 10.5 (or about 8 to about 9.5), such as by the addition of chemicals, e.g., sodium hydroxide, lime, sodium carbonate, trisodium phosphate, or the like to help release additional oil from the germ. Also, cell wall breaking enzymes, e.g., protease and the like, and/or chemicals, e.g., sodium sulfite and the like, may be added here to help release additional oil from the germ. In one example, the fiber can be held in the tank for about 1 hour at a temperature of about 140° F. to about 200° F. (or about 180° F. to about 200° F.). Thereafter, the fiber can be subjected to a grind step to release more oil and protein from the fiber. The fiber produced by these additional treatment steps can give a much lower oil (less than 2%) and lower protein (less than 10%) and can be used for secondary alcohol production.

The centrate from the fiber/protein separation step 416 goes to a protein recovery/dewatering step 418, which uses, for example, a decanter, a nozzle centrifuge, or a disc decanter to recover the fine germ and protein (as well as spent yeast). These components are sent to a dryer 420 to yield a high value gluten/germ/yeast mix (protein meal) having about 60% gluten and about 40% germ/yeast. This system and method 400 will produce a protein yield of 5.5 lb/Bu, with about 45% protein purity. Alternatively, prior to the protein recovery/dewatering step 418, the centrate from the fiber/protein separation step 416 instead may first be optionally sent to a germ/gluten separation step 422 whereat the germ is separated from the gluten using, for example, a paddle screen or pressure screen. The germ is sent back to germ grind step 410 to extract more oil. The gluten is sent on to protein recovery/dewatering step 418, then to the protein dryer 420.

The overflow from the protein dewatering step 418 goes to an evaporator 424 to separate any oil therefrom and to produce syrup, which can be mixed with the DDG and dried, as represented by numeral 426, to give the low protein (less than 20%)/low oil (less than 8%) DDGS, such as for cows or pigs, particularly dairy cows. The DDGS contains less than about 20% protein, less than about 8% oil, and less than 4% starch.

In addition, an optional centrifugation step (not shown) may be provided to recover the xanthophyll content in the emulsion layer of the recovered oils, both prior to and after fermentation 412, and mixed with the protein co-product prior to drying to increase the feed value. Sodium sulfite, sulfur dioxide, or the like may be added to the wet protein cake, for example, to maintain more than a 20 ppm sulfur dioxide level before the wet protein cake is sent to the protein dryer 420. The sulfur dioxide can prevent the xanthophylls from decomposing inside the protein dryer 420. The overflow from the centrifuge(s) can go back to the oil storage tanks. In addition, although not shown, it should be understood that the fiber, protein, fine germ, and fine fiber of the stillage from distillation may be treated in a manner as illustrated at the back end of the methods 300, 400 of FIGS. 3 and 4.

With reference now to FIG. 5A, this figure depicts a flow diagram of a variation of the system and method 400 of FIG. 5. In this system and method 400a, the gluten meal is removed prior to fermentation 412. Recovery of the gluten meal before fermentation 412 can cut down on xanthophyll loss during fermentation 412 and subsequent distillation and protein recovery steps 414, 418.

As shown in FIG. 5A, after the solid/liquid separation step 406, the liquid portion can go to an oil/liquefied starch solution/gluten separation step 428 whereat the liquid portion is subjected to a disc centrifuge or disc decanter centrifuge to individually separate the oil and the gluten from the liquefied starch solution, which is sent to meet up with the treated solids portion prior to fermentation 412. A surfactant and/or a flocculent can be added at and/or prior to step 428 to help improve oil yield recovery, for example. At the oil/liquefied starch solution/gluten separation step 428, the liquefied starch solution is used as heavy media liquid to float and separate the oil, which has a density of about 0.9 to 0.92 grams/cc. The gluten is discharged as a cake from separation step 428 and goes to a gluten washing step 430 followed by a gluten drying step 432 to yield a high value gluten meal having a desirable percentage of xanthopyll, i.e., from about 100 mg/Lb to about 200 mg/Lb.

The remainder of the process is generally the same as that of FIG. 5, with the exception that the gluten meal has been recovered on the front end of the process, prior to fermentation 412. In particular, the optional germ/gluten separation step 422 (FIG. 5) is now an optional germ dewatering step 423, which uses, for example, a paddle screen or pressure screen to recover the fine germ. The germ is sent back to germ grind step 410 to extract more oil. The centrate is sent on to protein recovery/dewatering step 418, then the recovered components sent to the protein dryer 420. The resulting gluten/germ/yeast mix (protein meal) includes a lower percentage of gluten. The overflow from the protein recovery/dewatering step 418 still makes its way to the evaporator 424 to separate any oil therefrom and to produce syrup, which can be mixed with the DDG and dried to give the low protein (less than 20%)/low oil (less than 8%) DDGS.

With reference now to FIG. 5B, this figure depicts a flow diagram of a variation of the system and method 400 of FIG. 5. In this system and method 400b, the treated solids portion from the size reduction step 410 is first sent to a holding tank 434 then a solid/liquid separation step 436 before being combined together with the liquefied starch solution from the oil/liquefied starch separation step 408 at fermentation step 412.

In particular, as shown in FIG. 5B, the treated solids portion is mixed with cook water at holding tank 434 whereat the bonds between fiber, starch, protein, and oil of the fine germ and fine fiber can be further broken down. In addition, the pH of the fine germ can be adjusted here to about 8 to about 10.5 (or about 8 to about 9.5), such as by the addition of chemicals, e.g., sodium hydroxide, lime, sodium carbonate, trisodium phosphate, or the like, to help release oil from the germ. Also, cell wall breaking enzymes, e.g., protease and the like, and/or chemicals, e.g., sodium sulfite and the like, may be added here to help release oil from the germ. In one example, the fine germ can be held in the tank for about 1 hour at a temperature of about 140° F. to about 200° F. (or about 180° F. to about 200° F.).

After the holding tank 434, the slurry is sent to solid/liquid separation step 436 whereat the solids and liquids are separated by using, for example, a paddle screen or pressure screen. The size of the openings in the screen is larger than those of the screens used at solid/liquid separation step 406. In one example, the openings can range from about 75 microns to 400 microns. In another example, the openings in the screen are about 250 microns. The liquid centrate, which includes fine germ particles and fine fiber particles smaller than the size of the screen openings, is returned to mix with the milled grains and/or grain components after the hammer mill 402 and prior to liquefaction step 404 to form a slurry and for further processing, such as to recover additional oil co-product via oil/liquefied starch separation step 408. The solids portion from the solid/liquid separation step 436 and the liquefied starch solution from the oil/liquefied starch separation step 408 are then combined together and subjected to fermentation step 412 followed by distillation 414. The remainder of the process is generally the same as that of FIG. 5, including optionally sending the fine germ from gluten/separation step 422 back to germ grind step 410 to extract more oil, which will be further subjected to holding tank 434 and solid/liquid separation step 436. With this system and method 400b, the oil yield from the oil/liquefied starch solution separation step 408 is 1.0 lb/Bu or greater. In one example, the oil yield is from about 1.2 to about 1.4 lb/Bu. In addition, it should be understood that these additional steps 434 and 436 may be similarly implemented in the processes as shown in FIGS. 3-5A. A surfactant and/or a flocculent can be added at and/or prior to step 408 to help improve oil yield recovery, for example.

With reference now to FIG. 6, this figure schematically illustrates an embodiment of a method and system for producing a high protein corn meal, collectively numeral 500, from the whole stillage byproduct produced in a typical corn dry mill process 100 like that described in FIG. 2. The whole stillage byproduct contains a slurry of soluble and insoluble solids, i.e., the spent grains and/or grain components from the distillation and dehydration step 502, which includes protein, fiber, oil, and sugars that are processed in accordance with embodiments of this invention to produce a high protein corn meal that can be sold, e.g., as pig and chicken feed, at a higher cost per ton than typical DDGS or DWGS. In one embodiment, the resulting high protein corn meal includes at least 40 wt % protein on a dry basis as compared to a protein content of about 29% typically found in DDGS.

With further reference to FIG. 6, the whole stillage byproduct can be piped from the typical corn dry mill distillation and dehydration step 502 and subjected to an optional paddle screen 506. The optional paddle screen 506 is situated before a filtration centrifuge 510, which is described in U.S. Pat. No. 8,778,433, hereby incorporated by reference in its entirety, so as to aid ultimately in separation of the insoluble solids portion, e.g., fiber, from the filtrate portion by initially filtering out desirable amounts of water and protein and incidentally, small fiber fines from the whole stillage byproduct. This initial screening can help reduce the resulting load on the subsequent filtration centrifuge 510. The resulting underflow from the paddle screen 506 eventually joins with the underflow from the filtration centrifuge 510, as will be discussed in greater detail below.

To filter the whole stillage byproduct, the optional paddle screen 506 can include screen openings of no greater than about 150 microns. In another example, the paddle screen 34 can include openings therein of no greater than about 100 microns. In yet another example, the openings therein are no greater than about 50 microns. It should be understood that these values are exemplary and that those of ordinary skill in the art will recognize how to determine the size of the openings to achieve the desired filtration. In one example, the optional paddle screen 506 is a standard type paddle screen as is known in the art. One such suitable paddle screen 506 is the FQ-PS32 available from Fluid-Quip, Inc. of Springfield, Ohio. It should be understood that the optional paddle screen 506 may be replaced with other types of pre-concentration devices, e.g., a standard pressure screen or conic centrifuge, which can perform the desired filtration or preconcentration function. One such suitable pressure screen is the PS-Triple available from Fluid-Quip, Inc. of Springfield, Ohio.

With further reference again to FIG. 6, although a single filtration centrifuge 510 is depicted, it should be understood that a plurality of filtration centrifuges 510 may be situated in-line and utilized for separating the whole stillage byproduct into its insoluble solids portion (fiber) and filtrate portion. One such suitable filtration centrifuge is the FQ-FC3000 available from Fluid-Quip, Inc. of Springfield, Ohio. In an alternate embodiment, it is contemplated that the filtration centrifuge 510 can be replaced by a standard pressure screen, decanter centrifuge, a paddle screen, or other like devices as are known in the art to separate the whole stillage byproduct into the insoluble solids portion and filtrate portion then further processed as discussed below. One such suitable pressure screen is the PS-Triple available from Fluid-Quip, Inc. of Springfield, Ohio. One such suitable decanter centrifuge is the NX-944HS available from Alfa Laval of Lund, Sweden. And one such suitable paddle screen is the FQ-PS32 available from Fluid-Quip, Inc. of Springfield, Ohio.

As further shown in FIG. 6, the underflow from the filtration centrifuge 510 is piped to join up with the underflow from the optional paddle screen 34. After which time, the combined filtrates may be optionally subjected to a standard pressure screen 514, as is known in the art, to further aid in separation of any fine fiber from the filtrate portion. As indicated above, fiber having a size less than that of the screen of the filtration centrifuge 510 and/or optional paddle screen 506 may pass through and to subsequent steps of the corn dry mill process. At the pressure screen 514, the separated fine fiber can be separated from the filtrate and piped back to the filtration centrifuge 510 whereat the fine fiber may be filtered out. In one example, the matted network of fibers collected in a basket of the filtration centrifuge 510 may be used as a “filter” to separate the fine fiber from a liquid medium, and further processed as discussed below. One such suitable pressure screen 514 is the PS-Triple available from. Fluid-Quip, Inc. of Springfield, Ohio. In an alternate embodiment, the optional pressure screen 514 may be replaced with a standard paddle screen or decanter centrifuge, as are mentioned above, or other like device, to aid in separation of the fine fiber from the filtrate portion.

After the optional pressure screen 514, the underflow or remaining filtrate portion is then piped and subjected to a nozzle centrifuge 518, as is known in the art. The nozzle centrifuge 518 can be provided with washing capabilities so that fresh water, along with the filtrate portion, can be supplied to the nozzle centrifuge 518. The additional fresh water allows for easier separation of the filtrate into its protein portion and water soluble solids portion. The heavier protein portion separates from the water soluble solids portion and is removed as the underflow whereas the lighter water soluble solids portion, which includes oil, can be removed as the overflow. A surfactant and/or a flocculent can be added at and/or prior to the nozzle centrifuge 518 to help improve oil yield recovery, for example. One such suitable nozzle centrifuge 518 is the FQC-950 available from Fluid-Quip, Inc. of Springfield, Ohio. In an alternate embodiment, the nozzle centrifuge 518 can be replaced with a standard cyclone apparatus or other like device, as are known in the art, to separate the filtrate portion into the underflow protein portion and overflow water soluble solids portion. One such suitable cyclone apparatus is the RM-12-688 available from Fluid-Quip, Inc. of Springfield, Ohio.

The underflow protein portion from the nozzle centrifuge 518 is further piped and subjected to decanter centrifuge 522 to dewater the protein portion. The decanter centrifuge 522 is standard and known in the art. One such suitable decanter centrifuge 522 is the NX-944HS, available from Alfa Laval of Lund, Sweden. Other like devices are contemplated. The separated water portion or filtrate from the decanter centrifuge 522 may be recycled back, for example, to the liquefaction step 106 or the fermentation step 110 for reuse in the dry mill process (see FIG. 2). The dewatered protein portion is then dried, such as by being sent to a dryer 526, as is known in the art. In an alternate embodiment, the dewatered protein portion can be subjected to vacuum filtration or other drying methods, as are known in the art. The final dried protein product defines a high protein corn meal that includes at least 40 wt % protein on a dry basis and which may be sold as pig or chicken feed, for example. In another embodiment, the high protein corn meal includes at least 45 wt % protein on a dry basis. In another embodiment, the high protein corn meal includes at least 50 wt % protein on a dry basis. In yet another embodiment, the high protein corn meal includes at least 60 wt % protein on a dry basis. In still another embodiment, the high protein corn meal includes about 56 wt % protein on a dry basis. The resulting high protein corn meal may be sold at a much higher cost per ton than DDGS or DWGS.

With continuing reference to FIG. 6, the overflow water soluble solids portion, which includes oil as well as minerals and soluble proteins, is piped from the nozzle centrifuge 518 and subjected to a set of three evaporators 530 a, 530 b, and 530 c, as are known in the art, to begin separating the soluble solids from the water soluble solids portion. The evaporators 530 a-c evaporate the liquid portion of the water soluble solids portion. Thereafter, the water soluble solids portion can be piped and subjected to an optional oil recovery centrifuge 534, as is known in the art, so that oil can be removed therefrom. One such suitable oil recovery centrifuge 534 is the ORPX 617 available from Alfa Laval of Lund, Sweden. In one example, the final recovered oil product can include between about 40 wt % to about 60 wt % of the total corn oil in the corn. In comparison to typical oil recovery in a standard dry mill process, oil recovery centrifuge 534 can function at a higher capacity because the water soluble solids portion, which is subjected to the oil recovery centrifuge 534, includes less liquid and less protein than normal.

The remainder of the water soluble solids portion can be piped and subjected to another set of three evaporators 530 d, 530 e, and 530 f whereat the liquid portion is further evaporated from the water soluble solids portion to ultimately yield a soluble solids portion. While the water soluble solids portion is subjected to two sets of three evaporators 530a-c, 530d-f, it should be understood that the number of evaporators and sets thereof can be varied, i.e., can be more or less, from that shown depending on the particular application and result desired.

The resulting soluble solids portion may be combined with the insoluble solids portion, e.g., fiber, received from the filtration centrifuge 510 to provide distillers wet grains with soluble (DWGS), which may be further dried by a drier 536, as is known in the art, to provide distillers dry grains with solubles (DDGS), both of which can be sold to dairy and beef feedlots. In another example, the soluble solids portion may be used as a natural fertilizer.

Accordingly, in this dry mill process, neither the DDGS nor DWGS receive the typical concentrated syrup from the evaporators 530a-f. While this change from the typical dry mill process 100 results in a lower crude protein content in the DDGS and DWGS, this decrease is insubstantial, particularly, when the economic advantages of producing the high protein corn meal are realized. And, despite the lower protein content, the DDGS and DWGS may still be sold to beef and dairy feedlots as cattle feed.

Further modifications can be made to the above systems and methods 200, 200a, 300, 300a, 400, 400a, 400b, and 500 to improve co-product recovery, such as oil recovery, using surfactants, flocculants, and other emulsion-disrupting agents. In one example, emulsion-disrupting agents, such as surfactants and/or flocculants, may be added prior to steps in which emulsions are expected to form or after an emulsion forms in the method. For example, emulsions can form during centrifugation such that incorporation of surfactants and/or flocculants prior to or during centrifugation can improve oil separation.

Surfactants are compounds that lower the surface tension (or interfacial tension) between two liquids or between a liquid and a solid. Surfactants may act as detergents, wetting agents, emulsifiers, foaming agents, and dispersants. Flocculants are chemicals that can produce or enhance flocculation or aggregation of suspended particles from liquids or suspensions, for example. In the present invention, surfactants and flocculants may be used as demulsifiers to prevent emulsions or break those already formed.

FIGS. 3-6 show various possible points of addition of surfactants and/or flocculants, but the indicated positions are not at all intended to limit the invention in any way insofar as one skilled in the art will appreciate that other locations in the process may be desirable. Indeed, the surfactants and flocculants of the present invention may be added to the processes at any point prior to or during emulsion formation, as well as after emulsion formation. In one example, a surfactant and/or flocculant may be added prior to separation of a protein and oil/water mixture, added to an evaporation step, added to a syrup feed on the back end, and/or prior to any oil centrifugation.

A surfactant is a compound having both a hydrophilic and lipophilic group. In illustrative embodiments the hydrophilic group is an oligomeric or polymeric synthetic hydrophilic group. Exemplary hydrophilic groups include polyethylene oxide (e.g. a polyethylene glycol), a polyhydroyl (e.g. polyvinylalcohol), a polyamide (e.g. polyacrylamide), a polysulfonic acid (e.g. polystyrene sodium sulfonate), and/or a polycarboxylic acid (e.g. polyacrylic acid). In other embodiments, the hydrophilic group is an oligomeric or polymeric naturally-occurring hydrophilic group, such as polysaccharides, polyamino acids, polypeptides, and poly(hydroxycarboxylic) acids. In yet further embodiments, the hydrophilic group is an ionic moiety (e.g. a dissociated acid, base, or salt).

In illustrative embodiments, the lipophilic group is an alkyl that is optionally substituted, and/or optionally heteroatomic, and/or optionally conjugated, and/or optionally cyclic. In some embodiments, the lipophilic group may be the ester of a fatty acid (e.g. propionic acid, butyric acid, valeric acid, caproic acid, enanthic acid, caprylic acid, pelargonic acid, capric acid, undecylic acid, lauric acid, tridecylic acid, myristic acid, pentadecylic acid, palmitic acid, margaric acid, stearic acid, nonadecylic acid, arachidic acid, heneicosylic acid, behenic acid, tricosylic acid, lignoceric acid, pentacosylic acid, cerotic acid, heptacosylic acid, montanic acid, nonacosylic acid, melissic acid, henatriacontylic acid, lacceroic acid, psyllic acid, geddic acid, ceroplastic acid, hexatriacontylic acid, myristoleic acid, palmitoleic acid, sapienic acid, oleic acid, elaidic acid, vaccenic acid, linoleic acid, linoelaidic acid, α-linolenic acid, arachidonic acid, eicosapentaenoic acid, erucic acid, and docosahexaenoic acid). In other embodiments, the lipophilic group may be an alcohol. In another embodiment, the lipophilic group is an ethoxylated alcohol.

In further illustrative embodiments, surfactants my comprise polyols derived from sorbitol, isosorbide, or a sorbitan, including 1,4-sorbitan. For example, the surfactant may be selected from alkoxylated sorbitan monoalkylates, alkoxylated sorbitan dialkylates, alkyoxylated sorbitan trialkylates, and mixtures thereof. The alkoxylated alkylates of sorbitan may have an alkyl chain length of from about 6 to about 24 carbons. The alkoxylated sorbitan alkylates may be, for example, alkoxylated esters of sorbitan. The alkoxylated alkylate of sorbitan may be alkoxylated with from about 5 to about 100 moles of alkyl oxide, for instance from 5 to 60 moles, from 10 to 30 moles, or from 12 to 30 moles. The alkyl oxides may be ethylene oxide, propylene oxide, or a combination thereof. Exemplary alkoxylated alkylates of sorbitan include sorbitan monolaurate, sorbitan monooleate, sorbitan monopalmitate, or sorbitan monostearate, that have been alkoxylated with less than 50 moles of ethylene oxide, propylene oxide, or a combination thereof. For instance, from about 10 moles to about 30 moles, or from about 12 moles to about 25 moles, or about 20 moles, of ethylene oxide, propylene oxide, or a combination thereof may be used 20 moles of ethylene oxide or propylene oxide or a combination thereof. Additionally, the materials may be classified as generally recognized as safe such that they do not compromise the potential end use of the resulting dry distiller grain as a feedstock.

In certain embodiments, the surfactants are selected from alkoxylated esters of sorbitan, alkoxylated fatty alcohols, alkoxylated fatty acids, sulfonated alkoxylates, alkyl quaternary ammonium compounds, alkyl amine compounds, alkyl phenol ethoxylates, and mixtures thereof. In certain other embodiments, the surfactants are selected from fatty acid salts (sodium, ammonium or potassium) and low molecular weight silicone surfactants. The alkoxylate portion of the forgoing classes of chemicals may be any mixture of ethylene oxide and propylene oxide added in block or random fashion to the base molecule.

The surfactant may be a blend of materials as described above. Multiple functionalized polyols derived from a sorbitol, isosorbide, and/or sorbitan, including, 1,4-sorbitan, and can be mixed together and used as the surfactant.

In certain embodiments, further additives may be used in conjunction with the functionalized polyols. For example, the additives may include triglycerides, such as vegetable oil or mineral oil; liquid mixtures containing up to 5% by weight hydrophobic silica; and high melting point (greater than 60° C.) waxes. These additives are well known in the defoamer industry. Vegetable oils include but are not limited to soybean oil, canola, and corn oil. The triglyceride or the liquid mixtures containing up to 5% by weight hydrophobic silica or the high melting point wax can be added in an amount of from 1 to 100% by weight based on the weight of the surfactant and additive.

A flocculant can include, for example, multivalent cations, such as aluminum, iron, calcium, or magnesium. Such positively charged molecules can interact with negatively charged particles and molecules to reduce the barriers to aggregation. In addition, under appropriate pH and other conditions, such as temperature and salinity, flocculants can react with water to form insoluble hydroxides which, upon precipitating, link together to form long chains or meshes, physically trapping small particles into the larger floc. In other embodiments, flocculants can include polymers, e.g., long-chain polymers, such as modified polyacrylamides. These can be supplied in dry or liquid form. Liquid flocculants may be supplied as an emulsion with 10-40% actives with the remainder as a non-aqueous carrier fluid, surfactants, and latex. Such emulsion polymers may require “activation” or inversion of the emulsion so that the polymers molecules form an aqueous solution.

Specific types of flocculants can include, for example, alum, aluminum chlorohydrate, aluminum sulfate, calcium oxide, calcium hydroxide, iron sulfate, iron chloride, polyacrylamide, polyDADMAC, sodium aluminate, sodium silicate, as well as chitosan, gelatin, guar gum, and the like.

The surfactant or flocculant may be added to the desired portion of the process stream in an amount of from 50 to 5000 ppm based on the weight of the process stream. For instance, the amount of surfactant or flocculant may range from 100 to 5000 ppm, from 200 to 2500 ppm, from 300 to 1300 ppm, from 500 to 1100 ppm, or from 500 to 800 ppm. The surfactant or flocculant may added to the process stream in an amount of at least 50 ppm, at least 100 ppm, at least 200 ppm, or at least 300 ppm. The surfactant or flocculant may added to the process stream in an amount of less than 10,000 ppm, less than 5000 ppm, less than 2500 ppm, less than 1500 ppm, or less than 1000 ppm. Two or more types of surfactants or flocculants may be combined.

With specific reference now to FIGS. 3 and 3A, in systems and methods 200 and 200a, the surfactant and/or flocculant may be added at the soaking/cooking step 202, at the liquefaction step 206, to the holding tank 210, and/or at some point between the evaporator 226 and the DDG dryer 228, for example. Additionally, with specific reference to FIGS. 4 and 4A, in systems and methods 300 and 300a, the surfactant and/or flocculant may be added at the liquefaction step 304, at the protein dewater step 320, and/or to the holding tank 308, for example. As to FIGS. 5, 5A, and 5B, in systems and methods 400, 400a, and 400b, the surfactant and/or flocculant may be added at the liquefaction step 404, at the oil/liquefied starch solution separation step 408, and/or at the protein dewater step 418. And with specific reference to FIG. 6, in system and method 500, the surfactant and/or flocculant may be added with the water at the nozzle centrifuge 518 and/or at one or more of the evaporators 530a-f, for example. Again, the indicated positions are not at all intended to limit the invention in any way insofar as one skilled in the art will appreciate that other locations in the process may be desirable.

Accordingly, an improved system and method for separating high value co-products, such as oil, white fiber, and protein meal, from grains and/or grain components used for biochemical and/or biofuel production, such as alcohol production, which is an improvement over typical processes and others, is provided that overcomes drawbacks of current systems and methods. Such systems and methods improve co-product recovery, such as oil recovery, using surfactants, flocculants, and other emulsion-disrupting agents.

While the present invention has been illustrated by a description of various embodiments and while these embodiments have been described in considerable detail, it is not the intention of the applicant to restrict or in any way limit the scope of the appended claims to such detail. For example, although the various systems and methods described herein have focused on corn, virtually any type of grain and/or grain components, or starch containing component, including, but not limited to, wheat, barley, sorghum, rye, rice, oats, cassava and the like, can be used. It is also contemplated that any co-product, such as fiber protein from current corn wet mill processes or germ fractions and fiber fractions from current dry fractionation processes can be used. Also, it should be understood that alcohol production can include not only ethanol but methanol, butanol, and the like, as well as modifications and derivatives thereof. Additional advantages and modifications will readily appear to those skilled in the art. Thus, the invention in its broader aspects is therefore not limited to the specific details, representative apparatus and method, and illustrative example shown and described. Accordingly, departures may be made from such details without departing from the spirit or scope of applicant's general inventive concept.

What is claimed is:

1. A method for separating co-products from grains and/or grain components used for biochemical and/or biofuel production comprising:
in a corn dry-milling process for making a biochemical and/or biofuel, separating a whole stillage byproduct, via constituent particle sizes, into an insoluble solids portion and a thin stillage portion, which includes free oil and protein;
separating out a lighter water soluble solids portion, which includes the oil, from heavier constituents, including the protein, in the thin stillage portion, via constituent weights; and
separating the oil from the water soluble solids portion to provide an oil portion,
wherein at least one of a surfactant or flocculent is added to the thin stillage portion or water soluble solids portion prior to separating the oil from the water soluble solids portion.

2. The method of claim 1 wherein separating the oil from the water soluble solids portion includes subjecting the water soluble solids portion to an oil recovery centrifuge to separate the oil from the water soluble solids portion to recover the oil portion.

3. The method claim 1 wherein the water soluble solids portion is subjected to evaporation prior to separating the oil from the water soluble solids portion to provide an oil portion.

4. The method of claim 1, wherein the surfactant or flocculent is added to the thin stillage portion prior to separating the oil from the water soluble solids portion.

5. The method of claim 1, wherein the surfactant or flocculent is added to the water soluble solids portion prior to separating the oil from the water soluble solids portion.

6. The method of claim 1, wherein the at least one surfactant is added to the thin stillage portion or water soluble solids portion prior to separating the oil from the water soluble solids portion.

7. The method of claim 6, wherein the surfactant comprises a hydrophilic group and a lipophilic group, the lipophilic group selected from the group consisting of esters of a fatty acid, alcohols, ethoxylated alcohols, and mixtures thereof.

8. The method claim 6, wherein the surfactant is selected from the group consisting of polyols derived from sorbitol, isosorbide, sorbitan, and mixtures thereof.

9. The method of claim 6, wherein the surfactant is selected from the group consisting of alkoxylated esters of sorbitan, alkoxylated fatty alcohols, alkoxylated fatty acids, sulfonated alkoxylates, alkyl quaternary ammonium compounds, alkyl amine compounds, alkyl phenol ethoxylates, fatty acid salts, low molecular weight silicone surfactants, and mixtures thereof.

10. The method of claim 1, wherein the at least one flocculant is added to the thin stillage portion or water soluble solids portion prior to separating the oil from the water soluble solids portion.

11. The method of claim 10, wherein the flocculant includes a polyacrylamide or a multivalent cation selected from aluminum, iron, calcium, or magnesium.

12. The method of claim 1, wherein the biochemical and/or biofuel production is alcohol production.
